(19) United States
(12) Patent Application Publication
(10) Pub. No.: US 2026/0202536 A1
(43) Pub. Date: Jul. 16, 2026

(54) SIMULTANEOUS MULTI-NODE SENSING OF TARGET OBJECTS

(71) Applicant: QUALCOMM Incorporated, San Diego, CA (US)

(72) Inventors: Min HUANG, Beijing (CN); Jing DAI, Beijing (CN); Hao XU, Beijing (CN)

(21) Appl. No.: 19/134,187

(22) PCT Filed: Jan. 31, 2023
(86) PCT No.: PCT/CN2023/073933

§ 371 Date: May 29, 2025

(51) Int. Cl. G01S 13/58; H04B 7/04

(52) U.S. Cl. CPC G01S 13/581; H04B 7/04013

(57) ABSTRACT

A wireless device may obtain a first configuration of a first set of sensing signals associated with a first reflection path. Each of the first set of sensing signals may be associated with a first time-domain rotation coefficient. The wireless device may receive the first set of sensing signals via the first reflection path. The wireless device may calculate a first Doppler frequency of a target object based on the first set of sensing signals and the first time-domain rotation coefficient. To calculate the first Doppler frequency of the target object, the wireless device may calculate a multiplicative factor for each of a set of periodical time occasions of the first set of sensing signals based on the first time-domain rotation coefficient, and may measure the first set of sensing signals based on a corresponding calculated multiplicative factor for each of the first set of periodical time occasions.

### TECHNICAL FIELD

The present disclosure relates generally to communication systems, and more particularly, to a wireless sensing system of target objects.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a sensing receiver. The apparatus may obtain a first configuration of a first set of sensing signals associated with a first reflection path. Each of the first set of sensing signals may be associated with a first time-domain rotation coefficient. The apparatus may receive the first set of sensing signals via the first reflection path. The apparatus may calculate a first Doppler frequency of a target object based on the first set of sensing signals and the first time-domain rotation coefficient. The apparatus may calculate a multiplicative factor for each of a set of periodical time occasions of the first set of sensing signals based on the first time-domain rotation coefficient. The apparatus may measure the first set of sensing signals based on a corresponding calculated multiplicative factor for each of the first set of periodical time occasions.

In an aspect of the disclosure, a method, a computer-readable medium, and an apparatus are provided. The apparatus may include a sensing transmitter. The apparatus may obtain a first configuration of a first set of sensing signals associated with a first reflection path. Each of the first set of sensing signals may be associated with a first time-domain rotation coefficient. The apparatus may forward the first set of sensing signals based on the first time-domain rotation coefficient. The apparatus may calculate a multiplicative factor for each of a set of periodical time occasions of the first set of sensing signals based on the first time-domain rotation coefficient. To forward the first set of sensing signals, the apparatus may transmit or reflect the first set of sensing signals based on a corresponding calculated multiplicative factor for each of the set of periodical time occasions.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating an example of sensing based on measurements of sensing signals reflected off of a target object, in accordance with various aspects of the present disclosure.

FIG. 6 is a diagram illustrating an example of a reflective wireless device configured to reflect one or more signals from a first wireless device to a second wireless device, in accordance with various aspects of the present disclosure.

FIG. 7A is a diagram illustrating an example of a plurality of wireless devices performing monostatic sensing on a target object, in accordance with various aspects of the present disclosure.

FIG. 7B is a diagram illustrating an example of a plurality of wireless devices performing bistatic sensing on a target object, in accordance with various aspects of the present disclosure.

FIG. 7C is a diagram illustrating an example of a wireless device performing monostatic sensing on a target object using a plurality of reflective wireless devices, in accordance with aspects of the present disclosure.

FIG. 7D is a diagram illustrating an example of a plurality of wireless device performing bistatic sensing on a target object using a plurality of reflective wireless devices, in accordance with various aspects of the present disclosure.

FIG. 8A is a diagram illustrating an example of a plurality of multiplicative factors used for discrete reflective paths.

FIG. 8B is a diagram illustrating an example of a plurality of Doppler spectrums associated with discrete reflective paths.

FIG. 9 is a connection flow diagram illustrating an example of communications between wireless devices configured to assist a network node in performing sensing on a target object, in accordance with various aspects of the present disclosure.

FIG. 10 is a connection flow diagram illustrating an example of communications between wireless devices configured to assist a network node in performing sensing on a target object, in accordance with various aspects of the present disclosure.

FIG. 11 is a connection flow diagram illustrating an example of communications between a wireless device and reconfigurable intelligent surfaces (RISs) configured perform sensing on a target object, in accordance with various aspects of the present disclosure.

FIG. 12 is a connection flow diagram illustrating an example of communications between wireless devices and RISs configured to perform sensing on a target object, in accordance with various aspects of the present disclosure.

FIG. 13 is a flowchart of a method of wireless communication.

FIG. 14 is another flowchart of a method of wireless communication.

FIG. 15 is another flowchart of a method of wireless communication.

FIG. 16 is another flowchart of a method of wireless communication.

FIG. 17 is another flowchart of a method of wireless communication.

FIG. 18 is another flowchart of a method of wireless communication.

FIG. 19 is a diagram illustrating an example of a hardware implementation for an example apparatus and/or network entity.

FIG. 20 is a diagram illustrating an example of a hardware implementation for an example network entity.

FIG. 21 is a diagram illustrating an example of a hardware implementation for an example network entity.

### DETAILED DESCRIPTION

When sensing a target object, a wireless device may transmit a sensing signal to a target object and receive the sensing signal from the target object to measure a Doppler frequency of the target object in one direction. While the wireless device may calculate a velocity of the target object in the incident direction of the target object using the measurement of the Doppler frequency, the wireless device may not be able to calculate the velocity of the target object in a direction perpendicular to the incident direction without performing an additional sensing measurement at an angle to the incident direction of the target object. However, if a plurality of sets of sensing signals are transmitted at a target object, the sensing signals may interfere with one another.

A configuration device, such as a sensing processing entity or a sensing transmitter, may configure a discrete time-domain rotation coefficient for each reflection path. A sensing transmitter may use the time-domain rotation coefficient to rotate a base sensing reference signal based on the time-domain rotation coefficient. A sensing receiver may use the time-domain rotation coefficient to calculate a Doppler frequency based on the received sensing signal and the time-domain rotation coefficient. The time-domain rotation coefficient may be used to avoid interference between simultaneously transmitted sensing signals while enhancing the signal strength of a sensing signal. In some aspects, a reflecting device such as a reconfigurable intelligent surface (RIS), may be configured to use the time-domain rotation coefficient to reflect a base sensing reference signal based on the time-domain rotation coefficient. A sensing receiver may use the time-domain rotation coefficient to calculate a Doppler frequency based on the received sensing signal and the time-domain rotation coefficient. Again, the time-domain rotation coefficient may be used to avoid interference between simultaneously transmitted sensing signals while enhancing the signal strength of a sensing signal.

A first wireless device, such as a sensing transmitter, may be configured to obtain a first configuration of a first set of sensing signals associated with a first reflection path. Each of the first set of sensing signals may be associated with a first time-domain rotation coefficient. The first wireless device may forward the first set of sensing signals based on the first time-domain rotation coefficient. The first wireless device may calculate a multiplicative factor for each of a set of periodical time occasions of the first set of sensing signals based on the first time-domain rotation coefficient. To forward the first set of sensing signals, the first wireless device may transmit or reflect the first set of sensing signals based on a corresponding calculated multiplicative factor for each of the set of periodical time occasions.

A second wireless device, such as a sensing receiver, may obtain a first configuration of a first set of sensing signals associated with a first reflection path. Each of the first set of sensing signals may be associated with a first time-domain rotation coefficient. The second wireless device may receive the first set of sensing signals via the first reflection path. The second wireless device may calculate a first Doppler frequency of a target object based on the first set of sensing signals and the first time-domain rotation coefficient. The second wireless device may calculate a multiplicative factor for each of a set of periodical time occasions of the first set of sensing signals based on the first time-domain rotation coefficient. The second wireless device may measure the first set of sensing signals based on a corresponding calculated multiplicative factor for each of the first set of periodical time occasions.

Particular aspects of the subject matter described in this disclosure can be implemented to realize one or more of the following potential advantages. In some examples, the described techniques can be used to measure a velocity of a target object using a plurality of simultaneously transmitted sensing signals, while reducing interference between the sensing signals and enhancing the signal strength of the sensing signals.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

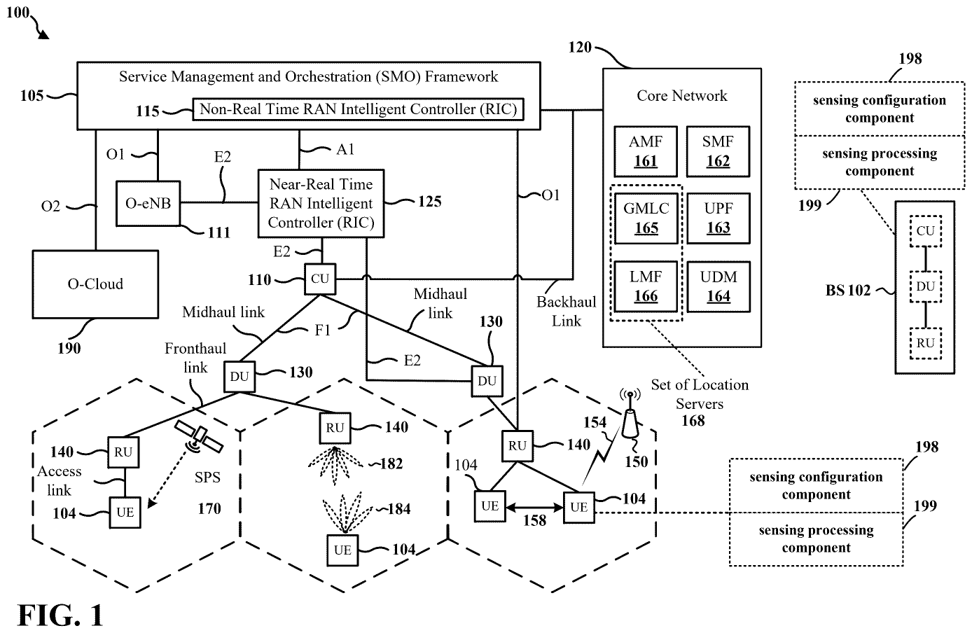

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a component 198 that may be configured to obtain a first configuration of a first set of sensing signals associated with a first reflection path. Each of the first set of sensing signals may be associated with a first time-domain rotation coefficient. The component 198 may be configured to receive the first set of sensing signals via the first reflection path. The component 198 may be configured to calculate a first Doppler frequency of a target object based on the first set of sensing signals and the first time-domain rotation coefficient. In certain aspects, the base station 102 may have a component 199 that may be configured to obtain a first configuration of a first set of sensing signals associated with a first reflection path. Each of the first set of sensing signals may be associated with a first time-domain rotation coefficient. The component 199 may forward the first set of sensing signals based on the first time-domain rotation coefficient. The time-domain rotation coefficient may be used to generate a multiplicative factor used to rotate the sensing signal relative to other sensing signals, allowing a wireless device that receives the sensing signal to measure the sensing signal without interference from other simultaneously transmitted sensing signals.

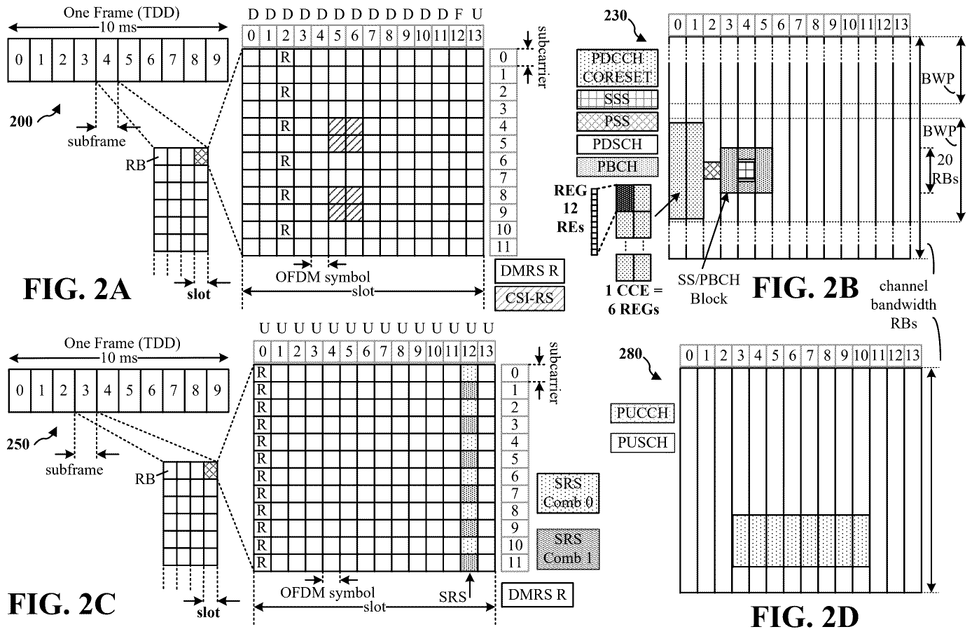

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| μ | SCS Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

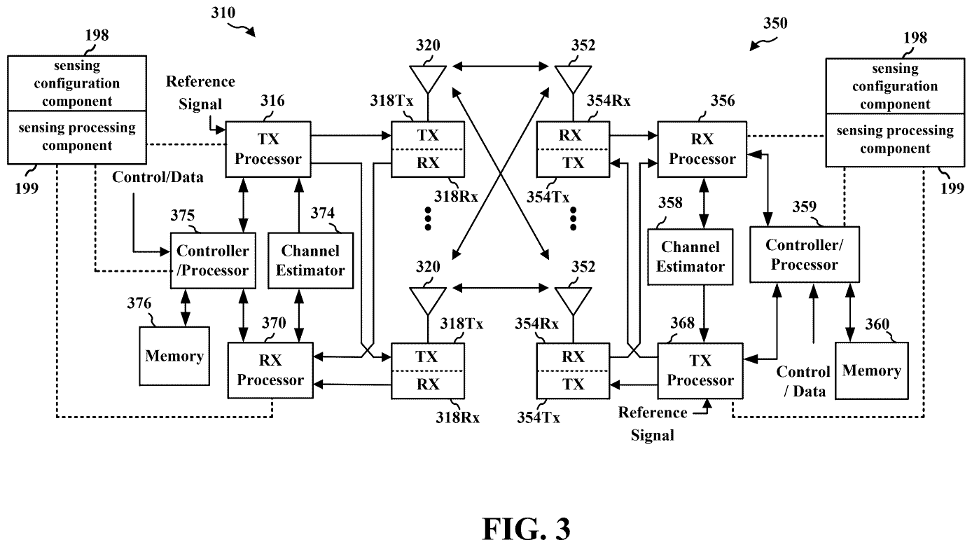

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the sensing configuration component 198 of FIG. 1.

At least one of the TX processor 368, the RX processor 356, and the controller/processor 359 may be configured to perform aspects in connection with the sensing processing component 199 of FIG. 1.

At least one of the TX processor 316, the RX processor 370, and the controller/processor 375 may be configured to perform aspects in connection with the sensing configuration component 198 of FIG. 1.

At least one of the TX processor 316, the RX processor 370, and the controller/processor 375 may be configured to perform aspects in connection with the sensing processing component 199 of FIG. 1.

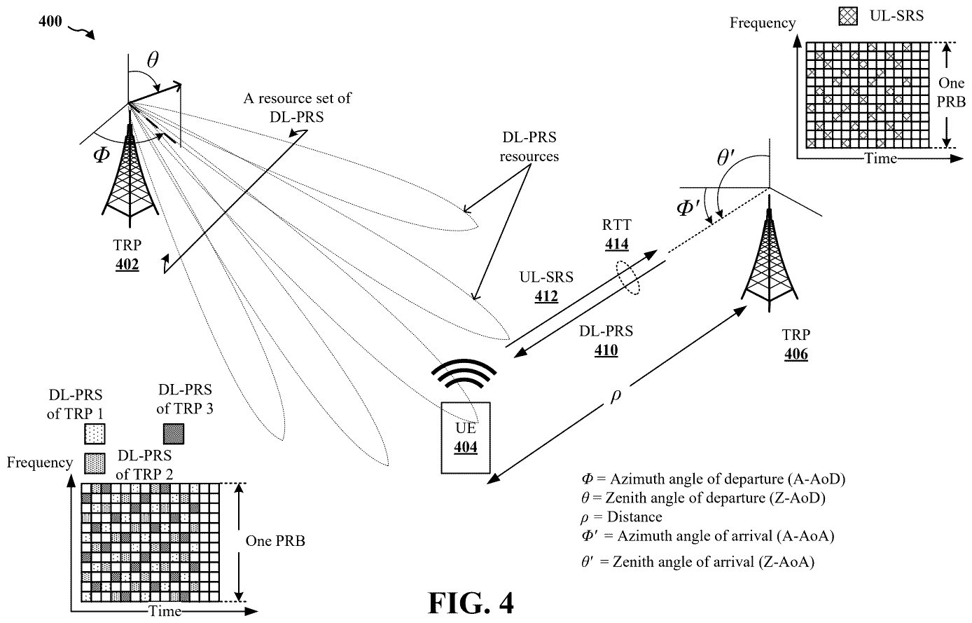

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s) 168) or the UE 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and optionally DL-PRS-RSRP of the received signals) using assistance data received from the positioning server, and the TRPs 402, 406 measure the gNB Rx-Tx time difference measurements (and optionally UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and optionally DL-PRS-RSRP) of downlink signals received from multiple TRPs 402, 406 at the UE 404. The UE 404 measures the DL RSTD (and optionally DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and optionally UL-SRS-RSRP) at multiple TRPs 402, 406 of uplink signals transmitted from UE 404. The TRPs 402, 406 measure the UL-RTOA (and optionally UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine to certainty, and/or enhance to supplement/complement measurements, and/or to substitute/provide for missing information.

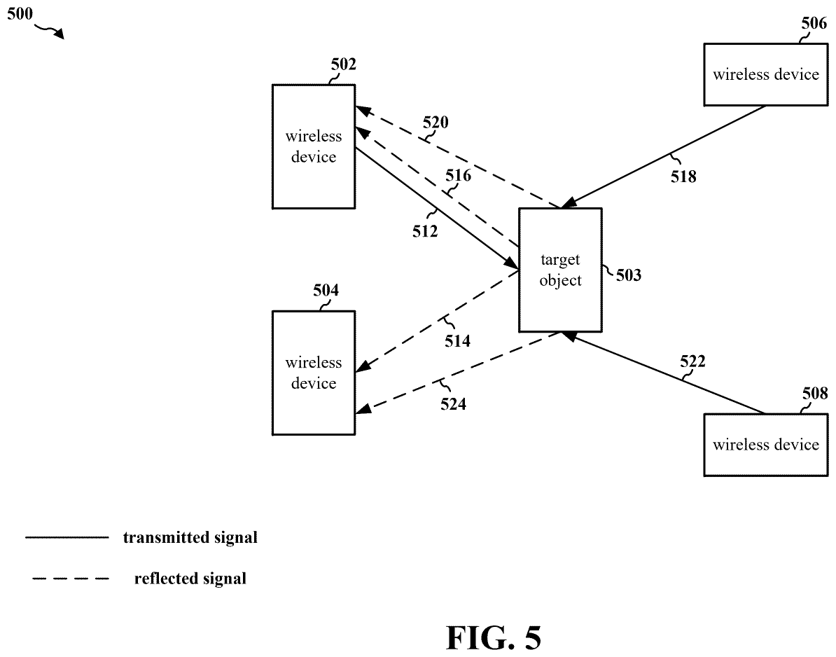

FIG. 5 is a diagram 500 illustrating an example of sensing based on sensing signal measurements. In one aspect, the wireless device 502 may perform monostatic sensing, where the wireless device 502 may transmit a set of sensing signals 512 at the target object 503, the target object 503 may reflect the set of sensing signals 512 as the reflected set of sensing signals 516 at the wireless device 502, and the wireless device 502 may measure the reflected set of sensing signals 516 from the target object 503. In another aspect, the wireless device 502 and the wireless device 504 may perform bistatic sensing, where the wireless device 502 may transmit a set of sensing signals 512 at the target object 503, the target object 503 may reflect the set of sensing signals 512 as the reflected set of sensing signals 514 at the wireless device 504, and the wireless device 504 may measure the reflected set of sensing signals 514 from the target object 503. In another aspect the wireless device 502 and the wireless device 506 may perform multi-static sensing, where in addition to the wireless device 502 measuring the reflected set of sensing signals 516 from the target object 503 using monostatic sensing, the wireless device 506 may transmit a set of sensing signals 518 at the target object 503, the target object 503 may reflect the set of sensing signals 518 as the reflected set of sensing signals 520 at the wireless device 502, and the wireless device 502 may measure the reflected set of sensing signals 520 from the target object 503. In another aspect the wireless device 502, the wireless device 504, and the wireless device 508 may perform multi-static sensing, where in addition to the wireless device 504 measuring the reflected set of sensing signals 514 from the target object 503 using bistatic sensing, the wireless device 508 may transmit a set of sensing signals 522 at the target object 503, the target object 503 may reflect the set of sensing signals 522 as the reflected set of sensing signals 524 at the wireless device 504, and the wireless device 504 may measure the reflected set of sensing signals 524 from the target object 503. Each wireless device may be any wireless device configured to transmit or receive wireless signals, such as UEs, network nodes, TRPs, or base stations. For example, the wireless device 502 may be a network node configured to transmit the set of sensing signals 512 at the target object 503 and measure the reflected set of sensing signals 516 from the target object 503. In another example, the wireless device 502 may be a network node configured to transmit the set of sensing signals 512 at the target object 503, and the wireless device 504 may be a UE configured to measure the reflected set of sensing signals 514 from the target object 503.

The wireless device 502 may conduct one or more sensing measurements on the reflected set of sensing signals 516 and/or the reflected set of sensing signals 520. In one aspect, the wireless device 502 may calculate a distance or a range between the wireless device 502 and the target object 503 based on a round trip time (RTT) between when the wireless device 502 transmits the set of sensing signals 512 and when the wireless device 502 receives the reflected set of sensing signals 516. In one aspect, the wireless device 502 may calculate a distance or a range that the set of sensing signals 518 and the reflected set of sensing signals 520 travels based on a time between when the wireless device 506 transmits the set of sensing signals 518 and when the wireless device 502 receives the reflected set of sensing signals 520. In one aspect, the wireless device 502 may calculate a location of the target object 503 based on a plurality or range or distance measurements, for example via triangulation using known positions of the wireless devices 502 and 506 and the calculated range or distance measurements. In one aspect, the wireless device 502 may calculate a velocity of the target object 503 based on a first calculated location of the target object 503 based on the reflected set of sensing signals 516 and/or the reflected set of sensing signals 520 measured at a first time, and a second calculated location of the target object 503 based on the reflected set of sensing signals 516 and/or the reflected set of sensing signals 520 measured at a second time. In one aspect, the wireless device 502 may calculate an AoA of the reflected set of sensing signals 516 and/or an AoD of the set of sensing signals 512 based on a plurality of ports that transmitted the set of sensing signals 512 and a plurality of ports that received the reflected set of sensing signals 516. In one aspect, the wireless device 502 may calculate an AoA of the reflected set of sensing signals 520 and/or an AoD of the set of sensing signals 518 based on a plurality of ports that transmitted the set of sensing signals 518 and a plurality of ports that received the reflected set of sensing signals 520.

Similarly, the wireless device 504 may conduct one or more sensing measurements on the reflected set of sensing signals 514 and/or the reflected set of sensing signals 524. In one aspect, the wireless device 504 may calculate a distance or a range that the set of sensing signals 512 and the reflected set of sensing signals 514 travels based on a on a time between when the wireless device 502 transmits the set of sensing signals 512 and when the wireless device 504 receives the reflected set of sensing signals 514. In one aspect, the wireless device 504 may calculate a distance or a range that the set of sensing signals 522 and the reflected set of sensing signals 524 travels based on a time between when the wireless device 508 transmits the set of sensing signals 522 and when the wireless device 504 receives the reflected set of sensing signals 524. In one aspect, the wireless device 504 may calculate a location of the target object 503 based on a plurality or range or distance measurements, for example via triangulation using the known positions of wireless devices 502, 504, and 508, and the calculated range or distance measurements. In one aspect, the wireless device 504 may calculate a velocity of the target object 503 based on a first calculated location of the target object 503 based on the reflected set of sensing signals 514 and/or the reflected set of sensing signals 524 measured at a first time, and a second calculated location of the target object 503 based on the reflected set of sensing signals 514 and/or the reflected set of sensing signals 524 measured at a second time. In one aspect, the wireless device 504 may calculate an AoA of the reflected set of sensing signals 514 and/or an AoD of the set of sensing signals 512 based on a plurality of ports that transmitted the set of sensing signals 512 and a plurality of ports that received the reflected set of sensing signals 514. In one aspect, the wireless device 504 may calculate an AoA of the reflected set of sensing signals 524 and/or an AoD of the set of sensing signals 522 based on a plurality of ports that transmitted the set of sensing signals 522 and a plurality of ports that received the reflected set of sensing signals 524.

A network device or a UE configured to perform measurements on a set of reflected sensing signals may be configured to transmit a sensing signal report to a sensing server (e.g., an LMF) that coordinates a plurality of wireless devices to perform sensing on a target object. In order to perform Doppler estimates or velocity estimates of a target object, such as the target object 503 in FIG. 5, or of a UE, such as the UE 104 in FIG. 1, the receiver wireless device may be configured to measure a reflected set of sensing signals at multiple points of time. A transmitter wireless device may be configured to periodically transmit a radio wave that is reflected by the target object 503 to be received by a receiver wireless device. The receiver wireless device may estimate the Doppler frequency of the target object 503 as f_{d} based on a phase variation of the received signals over time as

$${f}_{d} = \frac{Δφ}{2 π T} .$$

The receiver wireless device may then calculate the velocity of the target object 503 with respect to the direction of the target object 503 relative to the receiver wireless device (the incident direction of the target object 503) based on

$$v = \frac{{f}_{d}}{{f}_{c}} \times c .$$

A wireless device acting as both a transmitter and a receiver wireless device, such as the wireless device 502, may calculate a velocity of the target object 503 in the incident direction of the target object 503 using the measurement of a Doppler frequency, for example by performing a sensing measurement on the set of sensing signals 516. Such a receiver wireless device may not be able to calculate the velocity of the target object 503 in a direction perpendicular to the incident direction without performing an additional sensing measurement at an angle to the incident direction of the target object 503, for example by performing a sensing measurement on the set of sensing signals 520, or by receiving sensing results from the wireless device 504 that performs a sensing measurement on the set of sensing signals 514 or the set of sensing signals 524. To obtain the full velocity information (value and direction) of the target object 503, a wireless device may measure sensing signals originating from two or more transmitter wireless devices to measure different velocity components of the target object 503. Then, the wireless device may calculate the full information (value and direction) of the velocity of the target object 503 using the plurality of measurements. In some aspects, a single transmitter wireless device may transmit a sensing signal to a target object via a plurality of reflection paths by using a RIS.

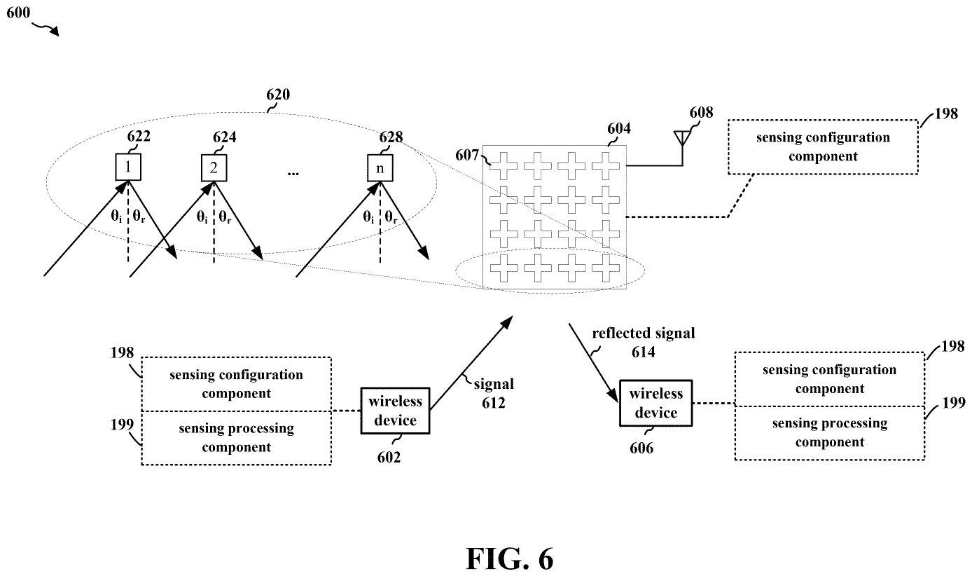

FIG. 6 is a diagram 600 illustrating an example of a RIS 604 configured to receive a signal 612 from a wireless device 602, and forward (e.g., reflect) a signal 614 towards a wireless device 606. The wireless device 602 may be a wireless device configured to transmit the signal 612, such as the UE 104 or the base station 102 in FIG. 1. The wireless device 606 may be a wireless device configured to receive the signal 614, such as the UE 104 or the base station 102 in FIG. 1. The RIS 604 may have an antenna 608 that may be used to transmit data, such as an indication of a frequency-domain compensation factor, to the wireless device 602 or to the wireless device 606. One or more of the meta-elements 607 of a meta-surface of the RIS 604 may be configured to reflect the signal 612 as the signal 614. One or more of the meta-elements 607 of the RIS 604 may be configured to sense one or more attributes of the signal 612, such as an AoA or a signal strength.

The RIS 604 may have an ultrathin surface inlaid with a plurality of meta-elements 607, which may also be referred to as sub-wavelength scatters or RIS elements. The electromagnetic response, such as phase shifts, of each of the meta-elements 607 may be controlled by programmable PIN diodes or varactor diodes. Each of the meta-elements 607 may be configured to reflect the signal 612 to a desired direction. The configuration of one or more reflective elements may be used to aim a signal 612 in a desired direction. For example, one or more reflection coefficients of one of the meta-elements 607 may be changed to alter a direction that the signal 614 is centered upon. For example, a first coefficient may be altered to change an amplitude of the signal 614 and a second coefficient may be altered to shift a phase of the signal 614. The configuration of the meta-elements 607 of the RIS 604 may depend on the knowledge of the direction of the incident wave of the signal 612. In other words, the accuracy of where a meta-element of the meta-elements 607 centers or aims the signal 614 may be increased using information about the direction that the signal 612 approaches the meta-elements 607 from, or an AoA of the signal 612 relative to the meta-elements 607.

The RIS 604 may allow the wireless device 602 and the wireless device 606 to communicate with one another using wireless signals even if there may not be a line of sight (LOS) path between the transceivers of the wireless device 602 and the wireless device 606. Without the RIS 604, the wireless device 602 may have limited covering distance due to in-return transmission. Without the RIS 604, the wireless device 602 may have a coverage hole in transmitting to wireless devices, such as wireless device 606, if there is no LOS link between the wireless device 602 and a transmission target. Without the RIS 604, the wireless device 602 may not have sufficient positioning reference points, as one network node may provide one reference point. With the RIS 604, the RIS 604 may extend the covering distance via RIS beamforming. With the RIS 604, the RIS 604 may eliminate a coverage hole by using the RIS 604 as a relay point. The RIS 604 may have flexible deployment to have a LOS link to the coverage hole of the wireless device 602. With the RIS 604, an extra reference point with the position of the RIS 604 may be added as a positioning reference points for positioning measurements.

The signal 612 may be transmitted towards the RIS 604 from the wireless device 602 at an incident angle θᵢ, and the signal 614 may be reflected or forwarded towards the wireless device 606 from the RIS 604 at a reflection angle θᵣ. The incident angle θᵢ and the reflection angle θᵣ may be estimated by the wireless device 602 in any suitable manner, for example based on a location indication of the wireless device 602, a location indication of the RIS 604, and a location indication of the wireless device 606. The wireless device 602 may transmit a query to a LMF, such as the LMF 166 in FIG. 1, to retrieve location information associated with the wireless device 602, the RIS 604, and/or the wireless device 606, respectively. In some aspects, at least one of the wireless device 602, the RIS 604, and/or the wireless device 606 may perform positioning using one or more positioning reference signals in order to retrieve location information associated with the wireless device 602, the RIS 604, and/or the wireless device 606, respectively. In some aspects, at least one of the wireless device 602, the RIS 604, and/or the wireless device 606 may perform sensing using one or more sensing reference signals in order to retrieve location information associated with the wireless device 602, the RIS 604, and/or the wireless device 606, respectively. In some aspects, the location/position of the wireless device 602, the RIS 604, and/or the wireless device 606 may be fixed.

A section 620 of the RIS 604 may have an element 622, an element 624, and an element 628. The elements may be identified as elements 1 to n. The signal 612 may approach each of the elements 622, 624, and 628 at an incident angle θ; and may be reflected by each of the elements 622, 624, and 628, respectively, at a reflection angle θᵣ. The equivalent channel response value of the nth element, such as the element 628, of the RIS 604 at a reflection angle θᵣₙ may be estimated as

$${h}_{n} = {e}^{j \frac{2 π {d}_{n}}{λ} ( {sin θ}_{i} + {sin θ}_{r} )} \times {α}_{n} {e}^{j {φ}_{n}} .$$

αₙe^{jφ}^{ₙ} may be the reflection coefficient of the element n, such as the element 628.
dₙ may be the distance between the nth element to the first element, such as the distance between the element 628 and the element 622.
j may be a complex value symbol.
λ may be the wavelength of the signal reflected off of the element n, such as the element 628.
αₙ may be an amplitude of a reflection coefficient at the nth element. On may be a phase of a reflection coefficient at the nth element.

The overall equivalent channel response value of all of the elements of the RIS 604 at the reflection angle θᵣ may be estimated as

$$h = {\sum }_{n = 1}^{N} {h}_{n} = {\sum }_{n = 1}^{N} {e}^{j \frac{2 π {d}_{n}}{λ} ( {sin θ}_{i} + {sin θ}_{r} )} \times {α}_{n} {e}^{j {φ}_{n}}$$

If the reflection coefficient satisfies αₙ=α, then the value of φₙ may be estimated as

$${φ}_{n} = - \frac{2 π {d}_{n}}{λ} ( sin {θ}_{i} + sin {θ}_{r} )$$

The reflected beam may point to the direction θᵣ.

The coefficient amplitude and phase values of each of the meta-elements 607 of the RIS 604 may be obtained from a limited candidate reflection coefficient set {(a₁, φ₁), (a₂, φ₂), . . . , (a_{M}, φ_{M})} by different configurations, where aₘ may be the amplitude of the mth candidate reflection coefficient and φₘ may be the phase of the mth candidate reflection coefficient. In other words, the actual beam shape may deviate from the ideal estimated beam direction θᵣ. The larger the number of meta-elements 607 of RIS 604, the closer the actual beam shape may be to the ideal beam, which may increase the accuracy of the estimated beam direction θᵣ.

For the RIS 604, the amplitude and the phase of reflection coefficient at each of the meta-elements 607 may vary with frequency. The amplitude and/or the phase relationship with frequency characteristics may depend on the hardware structure of the RIS 604. In some aspects, the coefficient phase of each meta-element may change substantially linearly with the frequency. In other aspects, the coefficient phase of each meta-element may change non-linearly with the frequency. In some aspects, the coefficient amplitude may have a slight variance with frequency. For each meta-element configuration, the reflection coefficient amplitude and phase may be frequency-dependent, and may be expressed by

$$ψ ( f ) = \{ ( {a}_{1} ( f ) , {ϕ}_{1} ( f ) ) , ( {a}_{2} ( f ) , {ϕ}_{2} ( f ) ) , … , ( {a}_{M} ( f ) , {ϕ}_{M} ( f ) ) \}$$

The wireless device 602 or the wireless device 606 may have a component 198 configured to transmit, to a first reconfigurable intelligent surface (RIS), a first configuration of a first set of sensing signals. Each of the first set of sensing signals may be associated with a first RIS reflection coefficient. The component 198 may transmit the first set of sensing signals along a first reflection path comprising the first RIS and a target object. The component 198 may transmit, to at least one of the first RIS or a second RIS, a second configuration of a second set of sensing signals, wherein each of the second set of sensing signals is associated with a second RIS reflection coefficient. The component 198 may transmit the second set of sensing signals along a second reflection path comprising at least one of the first RIS or the second RIS and the target object. The RIS may reflect the first set of sensing signals based on the first RIS reflection coefficient and may reflect the second set of sensing signals based on the second RIS reflection coefficient.

The wireless device 602 or the wireless device 606 may have a component 199 configured to obtain a first configuration of a first set of sensing signals associated with a first reflection path comprising a first RIS. Each of the first set of sensing signals may be associated with a first RIS reflection coefficient. The component 199 may receive the first set of sensing signals via the first reflection path. The component 199 may calculate a first Doppler frequency of a target object based on the first set of sensing signals and the first configuration. The component 199 may obtain a second configuration of a second set of sensing signals associated with a second reflection path comprising at least one of the first RIS or a second RIS. Each of the second set of sensing signals may be associated with a second RIS reflection coefficient. The component 199 may receive the second set of sensing signals via the second reflection path. The component 199 may calculate a second Doppler frequency of the target object based on the second set of sensing signals and the second configuration. A velocity of the target object may be calculated based on the first Doppler frequency and the second Doppler frequency.

When multiple transmitter wireless devices transmit sensing signals at a target object, such as the target object 503, to avoid mutual interference, each transmitter wireless device may be configured to transmit sensing signals in turns, or via different RF resources. If the transmitter wireless devices transmit sensing signals at the same time using the same RF resources, a receiver device may not be able to distinguish between reflection paths, particularly if two different transmitter wireless devices are similarly distanced from the target object. If the transmitter wireless devices transmit sensing signals at the same time using different RF resources, the smaller bandwidth of the different RF resources may be too weak to perform effective measurements, as each transmitter wireless device may use a fraction of the sensing radio resources that it may be able to use. This may result in bad sensing performance. However, using different sensing time occasions for each transmitter wireless device may increase both the time and the power consumption used by each transmitter device.

A transmitter wireless device may be configured to transmit a plurality of sensing signals for different reflection paths, where each reflection path may be associated with a different time-domain rotation coefficient. The transmitter wireless device may rotate the set of sensing signals for a reflection path based on the associated time-domain rotation coefficient, or a RIS may reflect the set of sensing signals for a reflection path based on the associated time-domain rotation coefficient, in order to allow for a receiver wireless device to differentiate between a plurality of sets of sensing signals received during a single time domain, where each of the plurality of sets of sensing signals are associated with a different reflection path.

A first wireless device, such as a sensing transmitter or a transmitter wireless device, may be configured to obtain a first configuration of a first set of sensing signals associated with a first reflection path. Each of the first set of sensing signals may be associated with a first time-domain rotation coefficient. The first wireless device may forward the first set of sensing signals based on the first time-domain rotation coefficient. The first wireless device may calculate a multiplicative factor for each of a set of periodical time occasions of the first set of sensing signals based on the first time-domain rotation coefficient. To forward the first set of sensing signals, the first wireless device may transmit or reflect the first set of sensing signals based on a corresponding calculated multiplicative factor for each of the set of periodical time occasions.

A second wireless device, such as a sensing receiver or a receiver wireless device, may obtain a first configuration of a first set of sensing signals associated with a first reflection path. Each of the first set of sensing signals may be associated with a first time-domain rotation coefficient. The second wireless device may receive the first set of sensing signals via the first reflection path. The second wireless device may calculate a first Doppler frequency of a target object based on the first set of sensing signals and the first time-domain rotation coefficient. The second wireless device may calculate a multiplicative factor for each of a set of periodical time occasions of the first set of sensing signals based on the first time-domain rotation coefficient. The second wireless device may measure the first set of sensing signals based on a corresponding calculated multiplicative factor for each of the first set of periodical time occasions.

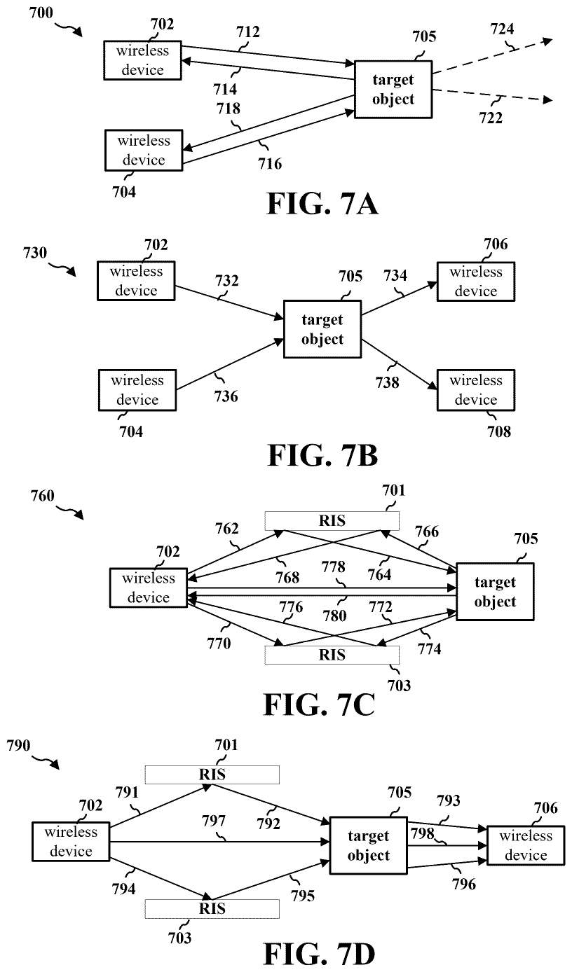

FIG. 7A is a diagram 700 illustrating an example of a wireless device 702 performing monostatic sensing on the target object 705 and the wireless device 704 performing monostatic sensing on the target object 705. The wireless device 702 may be a network node or a UE. The target object 705 may be measured via two discrete reflection paths. A first reflection path may be transmitted from the wireless device 702 as the sensing signal 712 at the target object 705, which may reflect the sensing signal 712 as the sensing signal 714 at the wireless device 702, which may then measure the first reflection path to determine a first Doppler frequency. A second reflection path may be transmitted from the wireless device 704 as the sensing signal 716 at the target object 705, which may reflect the sensing signal 716 as the sensing signal 718 at the wireless device 702, which may then measure the second reflection path to determine a second Doppler frequency. Each of the reflection paths may be assigned a discrete time-domain rotation coefficient. For example, a sensing entity coordinating the wireless device 702 and the wireless device 704 may assign a first time-domain rotation coefficient to the first reflection path including the sensing signal 712 and the sensing signal 714, and may assign a second time-domain rotation coefficient to the second reflection path including the sensing signal 716 and the sensing signal 718.

The wireless device 702 may transmit a sensing signal 712 to the target object 705, which may reflect off of the target object 705 as the sensing signal 714 received by the wireless device 702. The wireless device 702 may calculate a multiplicative factor for a beamforming weight for transmission of the sensing signal 712. The multiplicative factor may be calculated as

$${e}^{j 2 π {Δ}_{k} l T}$$

j may be a complex value symbol.
Δₖ may be the rotation coefficient of the kth reflection path (e.g., k=1 for the first reflection path, k=2 for the second reflection path, etc.).
l may be a periodical time occasion (e.g., l=0 for the first periodical time occasion for a set of sensing signals, l=1 for the second periodical time occasion for a set of sensing signals, l=2 for the third periodical time occasion for a set of sensing signals, etc.).
T may be a transmission interval, such as 1 symbol or 6 slots.

The wireless device 702 may multiply the base sensing signal by the multiplicative factor. For example, for a base sensing reference signal p_{k,l}, the wireless device 702 may transmit the sensing signal \tilde{p}_{k,l}=p_{k,l}×e^{j2πΔ}^{ₖ}^{lT}.

The wireless device 702 may perform sensing on the sensing signal 714 to measure a Doppler frequency associated with the velocity vector 722. The sensing signal 714 may be associated with the first reflection path from the wireless device 702 to the target object 705 as the sensing signal 712 and from the target object 705 to the wireless device 702 as the sensing signal 714. The wireless device 702 may estimate the channel based on the original sensing reference signal, resulting in an equivalent channel response \tilde{h}_{k,l}=h_{k,l}×e^{j2πΔ}^{ₖ}^{lT}, where h_{k,l} may be the original channel response at time occasion l.

The wireless device 704 may transmit a sensing signal 716 to the target object 705, which may reflect off of the target object 705 as the sensing signal 718 received by the wireless device 704. The wireless device 704 may calculate a multiplicative factor for a beamforming weight for transmission of the sensing signal 712. The multiplicative factor may be calculated as e^{j2πΔ}^{ₖ}^{lT}. The wireless device 704 may multiply the base sensing signal by the multiplicative factor. For example, for a base sensing reference signal p_{k,l}, the wireless device 704 may transmit the sensing signal \tilde{p}_{k,l}=p_{k,l}×e^{j2πΔ}^{ₖ}^{lT}.

The wireless device 704 may perform sensing on the sensing signal 718 to measure a Doppler frequency associated with the velocity vector 724. The sensing signal 718 may be associated with the second reflection path from the wireless device 704 to the target object 705 as the sensing signal 716 and from the target object 705 to the wireless device 704 as the sensing signal 718. The wireless device 704 may estimate the channel based on the original sensing reference signal, resulting in an equivalent channel response \tilde{h}_{k,l}=h_{k,l}×e^{j2πΔ}^{ₖ}^{lT}, where h_{k,l} may be the original channel response at time occasion l. The value of the time-domain rotation coefficient Δₖ for the wireless device 702 may be different than the value of the time-domain rotation coefficient Δₖ for the wireless device 704.

The wireless device 702 may calculate a Doppler frequency associated with the velocity vector 722 based on a measurement of the sensing signal 714. The wireless device 704 may calculate a Doppler frequency associated with the velocity vector 724 based on a measurement of the sensing signal 718. The wireless device 702 may transmit the first Doppler frequency based on the first reflection path to a sensing entity, and the wireless device 704 may transmit the second Doppler frequency based on the second reflection path to a sensing entity. The sensing entity may calculate a velocity of the target object 705 based on both Doppler frequencies.

FIG. 7B is a diagram 730 illustrating an example of a wireless device 702 performing bistatic sensing on the target object 705 with the wireless device 706, and the wireless device 704 performing bistatic sensing on the target object 705 with the wireless device 708. The wireless device 702 may be a network node or a UE. The wireless device 704 may be a network node or a UE. The wireless device 706 may be a network node or a UE. The wireless device 708 may be a network node or a UE. The target object 705 may be measured via two discrete reflection paths. A first reflection path may be transmitted from the wireless device 702 as the sensing signal 732 at the target object 705, which may reflect the sensing signal 712 as the sensing signal 734 at the wireless device 706, which may then measure the first reflection path to determine a first Doppler frequency. A second reflection path may be transmitted from the wireless device 704 as the sensing signal 736 at the target object 705, which may reflect the sensing signal 736 as the sensing signal 738 at the wireless device 708, which may then measure the second reflection path to determine a second Doppler frequency. Each of the reflection paths may be assigned a discrete time-domain rotation coefficient. For example, a sensing entity coordinating the wireless device 702, the wireless device 704, the wireless device 706, and the wireless device 708 may assign a first time-domain rotation coefficient to the first reflection path including the sensing signal 732 and the sensing signal 734, and may assign a second time-domain rotation coefficient to the second reflection path including the sensing signal 736 and the sensing signal 738.

The wireless device 702 may transmit a sensing signal 732 to the target object 705, which may reflect off of the target object 705 as the sensing signal 734 received by the wireless device 706. The wireless device 702 may calculate a multiplicative factor for a beamforming weight for transmission of the sensing signal 732. The multiplicative factor may be calculated as e^{j2πΔ}^{ₖ}^{lT}. The wireless device 702 may multiply the base sensing signal by the multiplicative factor. For example, for a base sensing reference signal p_{k,l}, the wireless device 702 may transmit the sensing signal \tilde{p}_{k,l}=p_{k,l}×e^{j2πΔ}^{ₖ}^{lT}.

The wireless device 706 may perform sensing on the sensing signal 734 to measure a first Doppler frequency. The sensing signal 734 may be associated with the first reflection path from the wireless device 702 to the target object 705 as the sensing signal 732 and from the target object 705 to the wireless device 706 as the sensing signal 734. The wireless device 706 may estimate the channel based on the original sensing reference signal, resulting in an equivalent channel response \tilde{h}_{k,l}=h_{k,l}×e^{j2πΔ}^{ₖ}^{lT}, where h_{k,l} may be the original channel response at time occasion l.

The wireless device 704 may transmit a sensing signal 736 to the target object 705, which may reflect off of the target object 705 as the sensing signal 738 received by the wireless device 708. The wireless device 704 may calculate a multiplicative factor for a beamforming weight for transmission of the sensing signal 732. The multiplicative factor may be calculated as e^{j2πΔ}^{ₖ}^{lT}. The wireless device 704 may multiply the base sensing signal by the multiplicative factor. For example, for a base sensing reference signal p_{k,l}, the wireless device 704 may transmit the sensing signal \tilde{p}_{k,l}=p_{k,l}×e^{j2πΔ}^{ₖ}^{lT}.

The wireless device 708 may perform sensing on the sensing signal 738 to measure a second Doppler frequency. The sensing signal 738 may be associated with the second reflection path from the wireless device 704 to the target object 705 as the sensing signal 736 and from the target object 705 to the wireless device 704 as the sensing signal 738. The wireless device 704 may estimate the channel based on the original sensing reference signal, resulting in an equivalent channel response \tilde{h}_{k,l}=h_{k,l}×e^{j2πΔ}^{ₖ}^{lT}, where h_{k,l} may be the original channel response at time occasion l.

The wireless device 706 may transmit the calculated first Doppler frequency to a sensing entity. The wireless device 708 may transmit the calculated second Doppler frequency to a sensing entity. The sensing entity may calculate a velocity of the target object 705 based on both Doppler frequencies.

FIG. 7C is a diagram 760 illustrating an example of a wireless device 702 performing monostatic sensing on the target object 705 with the RIS 701 and the RIS 703. The target object 705 may be measured via three discrete reflection paths. A first reflection path may be transmitted from the wireless device 702 as the sensing signal 762 at the RIS 701, which may reflect the sensing signal 762 as the sensing signal 764 at the target object 705, which may reflect the sensing signal 764 as the sensing signal 766 at the RIS 701, which may reflect the sensing signal 766 as the sensing signal 768 at the wireless device 702, which may then measure the first reflection path to determine a first Doppler frequency. A second reflection path may be transmitted from the wireless device 702 as the sensing signal 770 at the RIS 703, which may reflect the sensing signal 770 as the sensing signal 772 at the target object 705, which may reflect the sensing signal 772 as the sensing signal 774 at the RIS 703, which may reflect the sensing signal 774 as the sensing signal 776 at the wireless device 702, which may then measure the second reflection path to determine a second Doppler frequency. A third reflection path may be transmitted from the wireless device 702 as the sensing signal 778 at the target object 705, which may reflect the sensing signal 778 as the sensing signal 780 at the wireless device 702, which may then measure the third reflection path to determine a third Doppler frequency. Each of the reflection paths may be assigned a discrete time-domain rotation coefficient. For example, a sensing entity coordinating the wireless device 702, the RIS 701, and the RIS 703 may assign a first time-domain rotation coefficient to the first reflection path including the sensing signal 762, the sensing signal 764, the sensing signal 766, and the sensing signal 768, may assign a second time-domain rotation coefficient to the second reflection path including the sensing signal 770, the sensing signal 772, the sensing signal 774, and the sensing signal 776, and may assign a third time-domain rotation coefficient to the third reflection path including the sensing signal 778 and the sensing signal 780.

The wireless device 702 may transmit a sensing signal 762 to the RIS 701 along a first reflection path, which may reflect off of the RIS 701 as the sensing signal 764, which may reflect off of the target object 705 as the sensing signal 766, which may reflect off of the RIS 701 as the sensing signal 768, which may be received by the wireless device 702. The wireless device 702 may transmit an indication of its time-domain rotation coefficient Δₖ for the first reflection path to the RIS 701. The RIS 701 may calculate the reflection coefficient for the first reflection path based on the time-domain rotation coefficient Δₖ received from the wireless device 702. The RIS 701 may multiply its reflection coefficient by the multiplicative factor e^{j2πΔ}^{ₖ}^{lT}. For example, for a base sensing reference signal p_{k,l}, the wireless device 702 may transmit the sensing signal p_{k,l}. The RIS 701 may reflect the sensing signal 762 and the sensing signal 766 based on the multiplicative factor e^{j2πΔ}^{ₖ}^{lT} for the calculated time-domain rotation coefficient Δₖ for the first reflection path.

The wireless device 702 may perform sensing on the sensing signal 768 to measure a first Doppler frequency. The sensing signal 768 may be associated with the first reflection path including the sensing signal 762, the sensing signal 764, the sensing signal 766, and the sensing signal 768. The wireless device 702 may estimate the channel based on the original sensing reference signal p_{k,l}, resulting in an equivalent channel response \tilde{h}_{k,l}=h_{k,l}×e^{j2πΔ}^{ₖ}^{lT}, where h_{k,l} may be the original channel response at time occasion l.

The wireless device 702 may transmit a sensing signal 770 to the RIS 703 along a second reflection path, which may reflect off of the RIS 703 as the sensing signal 772, which may reflect off of the target object 705 as the sensing signal 774, which may reflect off of the RIS 703 as the sensing signal 776, which may be received by the wireless device 702. The wireless device 702 may transmit an indication of the time-domain rotation coefficient Δₖ for the second reflection path to the RIS 703. The time-domain rotation coefficient Δₖ for the second reflection path may be different than the time-domain rotation coefficient Δₖ for the first reflection path. The RIS 703 may calculate its reflection coefficient for the second reflection path based on the time-domain rotation coefficient Δₖ received from the wireless device 702. The RIS 703 may multiply its reflection coefficient by the multiplicative factor e^{j2πΔ}^{ₖ}^{lT}. For example, for a base sensing reference signal p_{k,l}, the wireless device 702 may transmit the sensing signal p_{k,l}. The RIS 703 may reflect the sensing signal 770 and the sensing signal 774 based on the multiplicative factor e^{j2πΔ}^{ₖ}^{lT} for the calculated time-domain rotation coefficient Δₖ for the second reflection path.

The wireless device 702 may perform sensing on the sensing signal 776 to measure a second Doppler frequency. The sensing signal 776 may be associated with the second reflection path including the sensing signal 770, the sensing signal 772, the sensing signal 774, and the sensing signal 776. The wireless device 702 may estimate the channel based on the original sensing reference signal p_{k,l}, resulting in an equivalent channel response \tilde{h}_{k,l}=h_{k,l}×e^{j2πΔ}^{ₖ}^{lT}, where h_{k,l} may be the original channel response at time occasion l.

The wireless device 702 may transmit a sensing signal 778 to the target object 705 along a third reflection path, which may reflect off of the target object 705 as the sensing signal 780, which may be received by the wireless device 702. The wireless device 702 may calculate a time-domain rotation coefficient Δₖ for the third reflection path for the sensing signal 778. The time-domain rotation coefficient Δₖ for the third reflection path may be different than the time-domain rotation coefficient Δₖ for the first and second reflection paths. For a base sensing reference signal p_{k,l}, the wireless device 702 may transmit the sensing signal p_{k,l}. In some aspects, the wireless device 702 may transmit the sensing signal 778 based on the multiplicative factor e^{j2πΔ}^{ₖ}^{lT} for the calculated time-domain rotation coefficient Δₖ for the third reflection path. The wireless device 702 may perform sensing on the sensing signal 780 to measure a third Doppler frequency. The sensing signal 776 may be associated with the third reflection path including the sensing signal 778, and the sensing signal 780. The wireless device 702 may estimate the channel based on the original sensing reference signal p_{k,l}, resulting in an equivalent channel response \tilde{h}_{k,l}=h_{k,l}×e^{j2πΔ}^{ₖ}^{lT}, where h_{k,l} may be the original channel response at time occasion l.

The wireless device 702 may calculate a velocity of the target object 705 based on the three Doppler frequencies based on the three reflection paths.

FIG. 7D is a diagram 790 illustrating an example of a wireless device 702 performing bistatic sensing on the target object 705 with the RIS 701, the RIS 703, and the wireless device 706. The target object 705 may be measured via three discrete reflection paths. A first reflection path may be transmitted from the wireless device 702 as the sensing signal 791 at the RIS 701, which may reflect the sensing signal 791 as the sensing signal 792 at the target object 705, which may reflect the sensing signal 792 as the sensing signal 793 at the wireless device 706, which may then measure the first reflection path to determine a first Doppler frequency. A second reflection path may be transmitted from the wireless device 702 as the sensing signal 794 at the RIS 703, which may reflect the sensing signal 794 as the sensing signal 795 at the target object 705, which may reflect the sensing signal 795 as the sensing signal 796 at the wireless device 706, which may then measure the second reflection path to determine a second Doppler frequency. A third reflection path may be transmitted from the wireless device 702 as the sensing signal 797 at the target object 705, which may reflect the sensing signal 797 as the sensing signal 798 at the wireless device 706, which may then measure the third reflection path to determine a third Doppler frequency. Each of the reflection paths may be assigned a discrete time-domain rotation coefficient. For example, a sensing entity coordinating the wireless device 702, the RIS 701, the RIS 703, and the wireless device 706 may assign a first time-domain rotation coefficient to the first reflection path including the sensing signal 791, the sensing signal 792, and the sensing signal 793, may assign a second time-domain rotation coefficient to the second reflection path including the sensing signal 794, the sensing signal 795, and the sensing signal 796, and may assign a third time-domain rotation coefficient to the third reflection path including the sensing signal 797 and the sensing signal 798.

The wireless device 702 may transmit a sensing signal 791 to the RIS 701 along a first reflection path, which may reflect off of the RIS 701 as the sensing signal 792, which may reflect off of the target object 705 as the sensing signal 793, which may be received by the wireless device 702. The wireless device 702 may transmit an indication of its time-domain rotation coefficient Δₖ for the first reflection path to the RIS 701. The RIS 701 may calculate its reflection coefficient for the first reflection path based on the time-domain rotation coefficient Δₖ received from the wireless device 702. The RIS 701 may multiply its reflection coefficient by the multiplicative factor e^{j2πΔ}^{ₖ}^{lT}. For example, for a base sensing reference signal p_{k,l}, the wireless device 702 may transmit the sensing signal p_{k,l}. The RIS 701 may reflect the sensing signal 791 based on the multiplicative factor e^{j2πΔ}^{ₖ}^{lT} for the calculated time-domain rotation coefficient Δₖ for the first reflection path.

The wireless device 706 may perform sensing on the sensing signal 793 to measure a first Doppler frequency. The sensing signal 793 may be associated with the first reflection path including the sensing signal 791, the sensing signal 792, and the sensing signal 793. The wireless device 706 may estimate the channel based on the original sensing reference signal p_{k,l}, resulting in an equivalent channel response \tilde{h}_{k,l}=h_{k,l}×e^{j2πΔ}^{ₖ}^{lT}, where h_{k,l} may be the original channel response at time occasion l.

The wireless device 702 may transmit a sensing signal 794 to the RIS 703 along a second reflection path, which may reflect off of the RIS 703 as the sensing signal 795, which may reflect off of the target object 705 as the sensing signal 796, which may be received by the wireless device 706. The wireless device 702 may transmit an indication of its time-domain rotation coefficient Δₖ for the second reflection path to the RIS 703. The RIS 703 may calculate its reflection coefficient for the second reflection path based on the time-domain rotation coefficient Δₖ received from the wireless device 702. The time-domain rotation coefficient Δₖ for the second reflection path may be different than the time-domain rotation coefficient Δₖ for the first reflection path. The RIS 703 may multiply its reflection coefficient by the multiplicative factor e^{j2πΔ}^{ₖ}^{lT}. For example, for a base sensing reference signal p_{k,l}, the wireless device 702 may transmit the sensing signal p_{k,l}. The RIS 703 may reflect the sensing signal 794 based on the multiplicative factor e^{j2πΔ}^{ₖ}^{lT} for the calculated time-domain rotation coefficient Δₖ for the second reflection path.

The wireless device 706 may perform sensing on the sensing signal 796 to measure a second Doppler frequency. The sensing signal 796 may be associated with the second reflection path including the sensing signal 794, the sensing signal 795, and the sensing signal 796. The wireless device 706 may estimate the channel based on the original sensing reference signal p_{k,l}, resulting in an equivalent channel response \tilde{h}_{k,l}=h_{k,l}×e^{j2πΔ}^{ₖ}^{lT}, where h_{k,l} may be the original channel response at time occasion l.

The wireless device 702 may transmit a sensing signal 797 to the target object 705 along a third reflection path, which may reflect off of the target object 705 as the sensing signal 798, which may be received by the wireless device 706. The wireless device 702 may calculate a time-domain rotation coefficient Δₖ for the third reflection path for the sensing signal 797. The time-domain rotation coefficient Δₖ for the third reflection path may be different than the time-domain rotation coefficient Δₖ for the first and second reflection paths. For a base sensing reference signal p_{k,l}, the wireless device 702 may transmit the sensing signal p_{k,l}. In some aspects, the wireless device 702 may transmit the sensing signal 798 based on the multiplicative factor e^{j2πΔ}^{ₖ}^{lT} for the calculated time-domain rotation coefficient Δₖ for the third reflection path.

The wireless device 706 may perform sensing on the sensing signal 798 to measure a third Doppler frequency. The sensing signal 798 may be associated with the third reflection path including the sensing signal 797, and the sensing signal 798. The wireless device 706 may estimate the channel based on the original sensing reference signal p_{k,l}, resulting in an equivalent channel response \tilde{h}_{k,l}=h_{k,l}×e^{j2πΔ}^{ₖ}^{lT}, where h_{k,l} may be the original channel response at time occasion l.

The wireless device 706 may calculate a velocity of the target object 705 based on the three Doppler frequencies based on the three reflection paths. The wireless device 706 may transmit a Doppler report of the three Doppler frequencies to a sensing entity, which may calculate a velocity of the target object 705 based on the three Doppler frequencies.

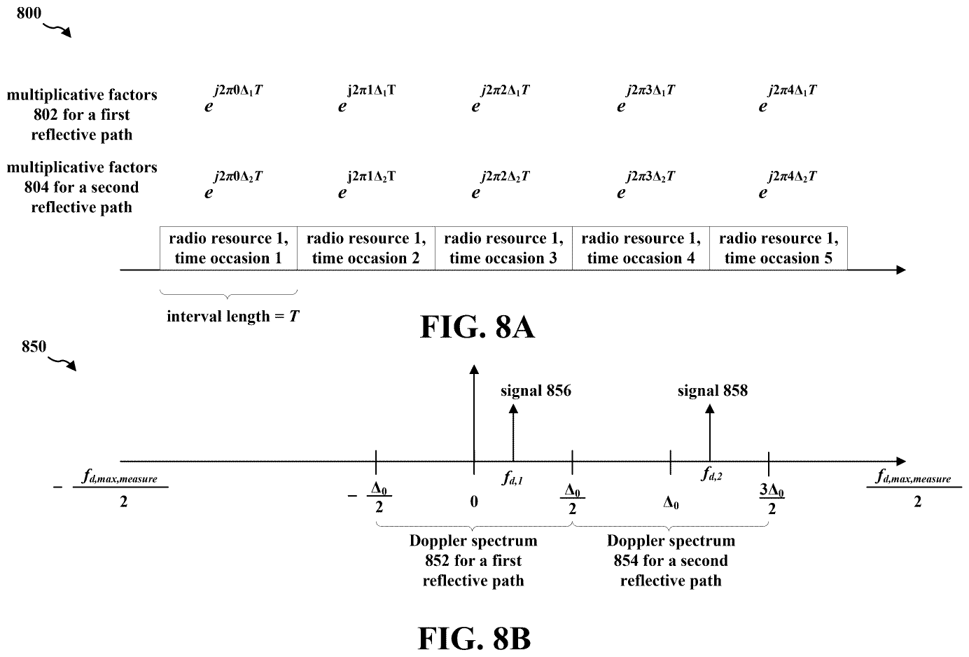

FIG. 8A is a diagram 800 illustrating an example of a set of multiplicative factors 802 associated with a first reflective path and a set of multiplicative factors 804 associated with a second reflective path. The set of multiplicative factors 802 and the set of multiplicative factors 804 may increase for each time occasion, as the value of l increments, while the time-domain rotation coefficient Δₖ may remain constant—Δ₁ for the first reflective path and Δ₂ for the second reflective path. E.g., Δₖ=(k−1)Δ₀ for scenarios with multiple wireless devices or Δₖ=kΔ₀ for scenarios with multiple RISs.

FIG. 8B is a diagram 850 illustrating an example of a Doppler spectrum 852 for a first reflective path and a Doppler spectrum 854 for a second reflective path. Δ₁=0, Δ₂=Δ₀. The Doppler spectrum 852 may be between

$$- \frac{{Δ}_{0}}{2} and \frac{{Δ}_{0}}{2}$$

for the first reflective path, as the signal 856 received via the first reflective path may not be shifted by a multiplicative factor, as the multiplicative factor may be 1. The Doppler spectrum 854 may be between Δ₀ and

$$\frac{3 {Δ}_{0}}{2}$$

for the second reflective path, as the signal 858 received via the second reflective path has been shifted by a multiplicative factor, as the multiplicative factor may be 2. As shown, the Doppler spectrums do not overlap, so interference between sensing signals between the first reflective path and the second reflective path may not interfere with one another.

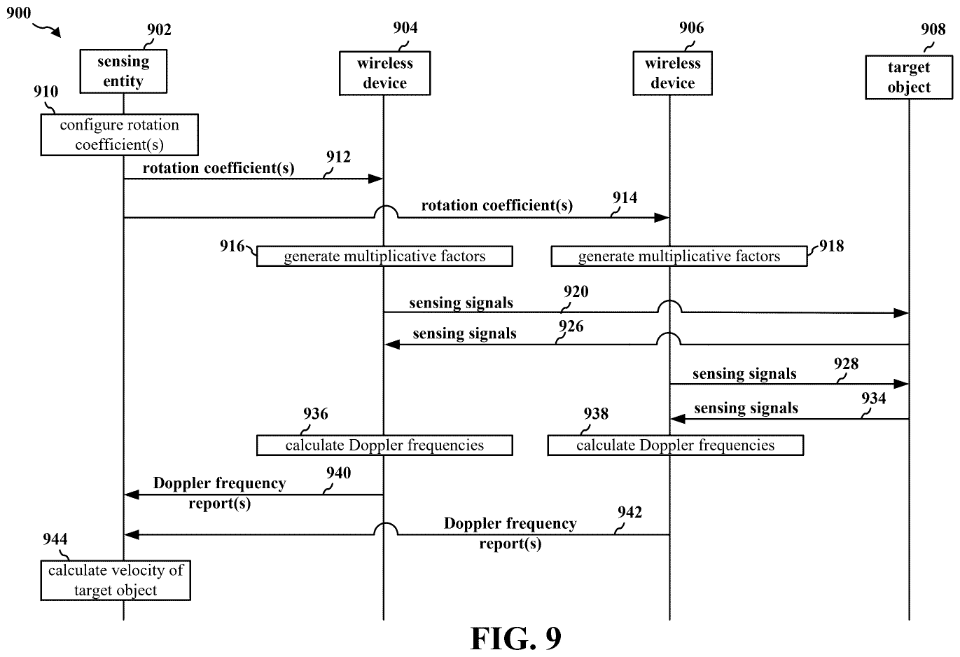

FIG. 9 is a connection flow diagram 900 illustrating an example of communications between a sensing entity 902, a wireless device 904, and a wireless device 906 configured to sense a target object 908. The wireless device 904 may be a network node or a UE. The wireless device 906 may be a network node or a UE. The sensing entity 902 may be a network node. The sensing entity 902 may be an LMF. The sensing entity 902 may coordinate the wireless device 904 to perform monostatic sensing on the target object 908 and the wireless device 906 to perform monostatic sensing on the target object 908. At 910, the sensing entity 902 may configure time-domain rotation coefficients for each of the reflection paths. A first reflection path from the wireless device 904 to the target object 908 and back again, and a second reflection path from the wireless device 906 to the target object 908 and back again. The sensing entity 902 may transmit an indication of a set of rotation coefficients 912 to the wireless device 904. The set of rotation coefficients 912 may be associated with the first reflection path including the set of sensing signals 920 and the set of sensing signals 926. The wireless device 904 may receive the indication of the set of rotation coefficients 912 from the sensing entity 902. The sensing entity 902 may transmit an indication of the set of rotation coefficients 914 to the wireless device 906. The set of rotation coefficients 914 may be associated with the second reflection path including the set of sensing signals 928 and the set of sensing signals 934. set of rotation coefficients 914 may be different from the set of rotation coefficients 912. The wireless device 906 may receive the indication of the set of rotation coefficients 914 from the sensing entity 902.

In some aspects, the sensing entity 902 may calculate each value

$${\{ {Δ}_{k} \}}_{k = 1}^{K}$$

for K transmitter wireless devices. For example, for two transmitter wireless devices, such as the wireless device 904 and the wireless device 906, the value of K may be 2. The sensing entity 902 may calculate

$${f}_{d , max} = \frac{{v}_{max}}{c} \cdot {f}_{c}$$

as the maximum value of the Doppler frequencies of all of the wireless device to target object 908 back to wireless device return paths, which may be determined by the maximum allowed moving velocity vₘₐₓ of the target object 908. To make the Doppler spectrum of each sensing signal non-overlapping, the sensing entity 902 may be configured to ensure that the maximum measurable Doppler frequency satisfies

$${f}_{d , max , measure} = \frac{1}{T} \geq K \cdot 2 {f}_{d , max} .$$

To ensure that the Doppler spectrum of each wireless device starts at an integer index, Δ₀ may be set to

$$\frac{{f}_{d , max , measure}}{K} = \frac{1}{K T} .$$

As such, the sensing entity 902 may configure each wireless device k with

$${Δ}_{k} = ( k - 1 ) {Δ}_{0} = \frac{k - 1}{K T} .$$

In some aspects,

$${L}_{0} = \frac{L}{K}$$

may be an integer.

At 916, the wireless device 904 may generate a set of multiplicative factors of the beamforming weights for the set of sensing signals 920 at multiple periodical time occasions. The set of multiplicative factors may be calculated as e^{j2πΔ}^{ₖ}^{lT} for multiple periodical time occasions l=0~L−1, where Δ₁ is the set of rotation coefficients 912 and T is an interval between the periodical time occasions. The wireless device 904 may transmit the set of sensing signals 920 based on the set of rotation coefficients 912. The set of sensing signals 920 may reflect off of the target object 908 as the set of sensing signals 926 to the wireless device 904.

At 918, the wireless device 906 may generate a set of multiplicative factors of the beamforming weights for the set of sensing signals 928 at multiple periodical time occasions. The set of multiplicative factors may be calculated as e^{j2πΔ}^{ₖ}^{lT} for multiple periodical time occasions l=0~L−1, where Δ₂ is the time-domain rotation coefficient for the set of rotation coefficients 914 and T is an interval between the periodical time occasions. The wireless device 906 may transmit the set of sensing signals 928 based on the set of rotation coefficients 914. The set of sensing signals 928 may reflect off of the target object 908 as the set of sensing signals 934 to the wireless device 906.

At 936, the wireless device 904 may calculate a Doppler frequency based on the set of rotation coefficients 912 associated with the first reflection path including the set of sensing signals 920 and the set of sensing signals 926. The wireless device 904 may transmit a set of Doppler frequency reports 940 to the sensing entity 902 based on the Doppler frequency calculated at 936. The sensing entity 902 may receive the set of Doppler frequency reports 940 from the wireless device 904.

At 938, the wireless device 906 may calculate a Doppler frequency based on the set of rotation coefficients 914 associated with the second reflection path including the set of sensing signals 928 and the set of sensing signals 934. The wireless device 906 may calculate the Doppler frequency based on the set of rotation coefficients 914. The wireless device 906 may transmit a set of Doppler frequency reports 942 to the sensing entity 902 based on the Doppler frequency calculated at 938. The sensing entity 902 may receive the set of Doppler frequency reports 942 from the wireless device 906.

In reception, the wireless device 904 and/or the wireless device 906 may estimate the Doppler frequency at its own equivalent Doppler spectrum based on Δₖ, in which mutual interference is avoided. In other words, the wireless device may estimate the channel based on the original sensing reference signal, resulting in an equivalent channel response \tilde{h}_{k,l}=h_{k,l}e^{-j2πΔ}^{ₖ}^{lT}, where h_{k,l} may be the original channel response at time occasion l. The wireless device may calculate the Doppler spectrum of the equivalent channel response of multiple occasions as \tilde{h}ₖ=[\tilde{h}_{k,0}, \tilde{h}_{k,1}, . . . , \tilde{h}_{k,L-1}]. Such an equivalent channel response may be a shifted version of the Doppler spectrum of the original channel response of multiple occasions hₖ=[h_{k,0}, h_{k,1}, . . . , h_{k,L-1}]. For example, the Doppler spectrums may be denoted as \tilde{H}ₖ=DFT(\tilde{h}ₖ), Hₖ=DFT (hₖ) which holds \tilde{H}ₖ(m)=Hₖ(mod(m+(k−1)L₀, L)). In other words, the equivalent Doppler spectrum of the kth wireless device may be shifted right-ward with the length of (k−1)L₀. Because each wireless device has a different shifting length, the equivalent Doppler spectrum may be non-overlapping, and thus when the wireless devices simultaneously transmit and receive, the mutual interference in their Doppler spectrums may be avoided, as shown in FIGS. 8A and 8B.

At 944, the sensing entity 902 may calculate a velocity of the target object 908 based on the set of Doppler frequency reports 940 and the set of Doppler frequency reports 942.

While FIG. 9 illustrates a pair of wireless devices performing monostatic sensing on the target object 908, more than two wireless device may perform monostatic sensing on the target object 908 to improve accuracy of the calculation at the sensing entity 902. Each reflective path may have a different time-domain rotation coefficient to prevent interference with one another. In some aspects, a plurality of wireless devices may be configured to perform bistatic sensing on the target object 908.

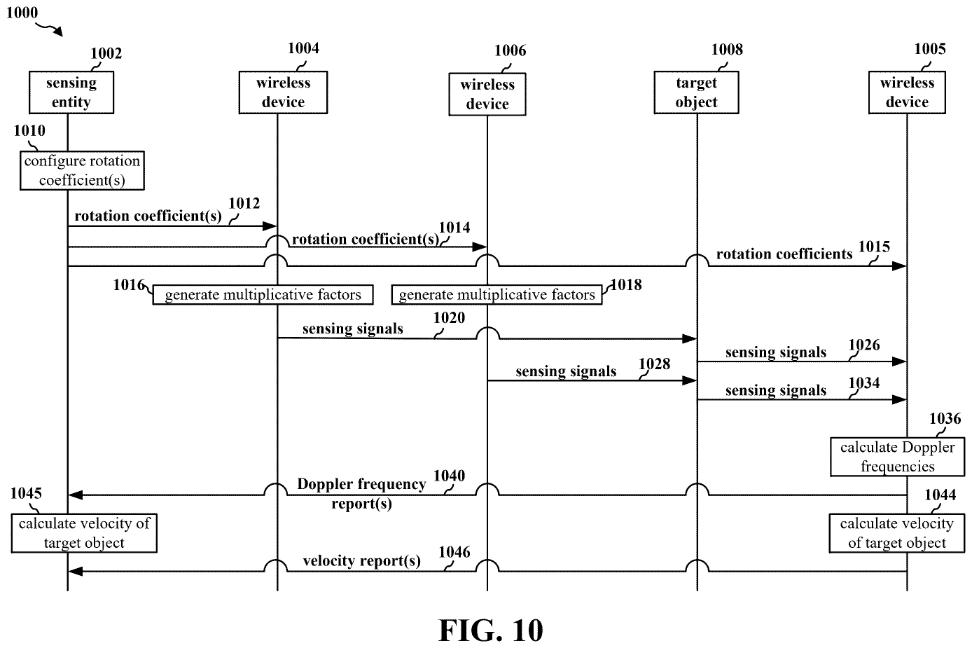

FIG. 10 is a connection flow diagram 1000 illustrating an example of communications between a sensing entity 1002, a wireless device 1004, a wireless device 1006, and a wireless device 1005 configured to sense a target object 1008. The wireless device 1004 may be a network node or a UE. The wireless device 1006 may be a network node or a UE. The wireless device 1005 may be a network node or a UE. The sensing entity 1002 may be a network node. The sensing entity 1002 may be an LMF. The sensing entity 1002 may coordinate the wireless device 1004 to perform bistatic sensing on the target object 1008 with the wireless device 1005. In other words, the wireless device 1004 may be a sensing transmitter and the wireless device 1005 may be a sensing receiver. The sensing entity 1002 may coordinate the wireless device 1006 to perform bistatic sensing on the target object 1008 with the wireless device 1005. In other words, the wireless device 1006 may be a sensing transmitter and the wireless device 1005 may be a sensing receiver. At 1010, the sensing entity 1002 may configure time-domain rotation coefficients for each of the reflection paths. A first reflection path from the wireless device 1004 to the target object 1008 to the wireless device 1005, and a second reflection path from the wireless device 1006 to the target object 1008 to the wireless device 1005. The sensing entity 1002 may transmit an indication of a time-domain rotation coefficient in the set of rotation coefficients 1012 to the wireless device 1004. The set of rotation coefficients 1012 may be associated with the first reflection path including the set of sensing signals 1020 and the set of sensing signals 1026. The wireless device 1004 may receive the indication of the time-domain rotation coefficient as the set of rotation coefficients 1012 from the sensing entity 1002. The sensing entity 1002 may transmit an indication of the time-domain rotation coefficient as the set of rotation coefficients 1014 to the wireless device 1006. The set of rotation coefficients 1014 may be associated with the second reflection path including the set of sensing signals 1028 and the set of sensing signals 1034. The set of rotation coefficients 1014 may be different from the set of rotation coefficients 1012. The wireless device 1006 may receive the indication of the time-domain rotation coefficient as the set of rotation coefficients 1014 from the sensing entity 1002. The sensing entity 1002 may transmit the set of rotation coefficients 1015 including the set of rotation coefficients 1012 and the set of rotation coefficients 1014 to the wireless device 1005. The wireless device 1005 may receive the set of rotation coefficients 1015 from the sensing entity 1002.

At 1016, the wireless device 1004 may generate a set of multiplicative factors of the beamforming weights for the set of sensing signals 1020 at multiple periodical time occasions. The set of multiplicative factors may be calculated as e^{j2πΔ}^{₁}^{lT} for multiple periodical time occasions l=0~L−1, where Δ₁ is the time-domain rotation coefficient of the set of rotation coefficients 1012 and T is an interval between the periodical time occasions. The wireless device 1004 may transmit the set of sensing signals 1020 based on the set of rotation coefficients 1012. The set of sensing signals 1020 may reflect off of the target object 1008 as the set of sensing signals 1026 to the wireless device 1005.

At 1018, the wireless device 1006 may generate a set of multiplicative factors of the beamforming weights for the set of sensing signals 1028 at multiple periodical time occasions. The set of multiplicative factors may be calculated as e^{j2πΔ}^{₂}^{lT} for multiple periodical time occasions l=0~L−1, where Δ₂ is the time-domain rotation coefficient of the set of rotation coefficients 1014 and T is an interval between the periodical time occasions. The wireless device 1006 may transmit the set of sensing signals 1028 based on the set of rotation coefficients 1014. The set of sensing signals 1028 may reflect off of the target object 1008 as the set of sensing signals 1034 to the wireless device 1005.

At 1036, the wireless device 1005 may calculate a first Doppler frequency based on the set of rotation coefficients 1012 associated with the first reflection path including the set of sensing signals 1020 and the set of sensing signals 1026. The wireless device 1005 may calculate a second Doppler frequency based on the set of rotation coefficients 1014 associated with the second reflection path including the set of sensing signals 1028 and the set of sensing signals 1034.

At 1044, the wireless device 1005 may calculate a velocity of the target object 1008 based on the calculated Doppler frequencies at 1036. The wireless device 1005 may transmit the set of velocity reports 1046 to the sensing entity 1002 based on the velocity calculated at 1044 and/or the calculated Doppler frequencies at 1036. The sensing entity 1002 may receive the set of velocity reports 1046 from the wireless device 1005.

In some aspects, the wireless device 1005 may transmit a set of Doppler frequency reports 1040 to the sensing entity 1002 based on the first and second Doppler frequencies calculated at 1036. The sensing entity 1002 may receive the set of Doppler frequency reports 1040 from the wireless device 1005. At 1045, the sensing entity 1002 may calculate a velocity of the target object 1008 based on the received set of Doppler frequency reports 1040.

In some aspects, the wireless device 1005 may transmit the calculated Doppler frequencies and/or the calculated velocity of the target object 1008 to the wireless device 1004 and/or the wireless device 1006. In some aspects, the sensing entity 1002 may transmit the calculated Doppler frequencies and/or the calculated velocity of the target object 1008 to the wireless device 1004 and/or the wireless device 1006.

While FIG. 10 illustrates a pair of wireless devices performing bistatic sensing on the target object 1008 with a common sensing receiver, more than two wireless device may perform bistatic sensing on the target object 1008 to improve accuracy of the calculation at the sensing entity 1002, and more than one sensing receiver may be configured with a plurality of sensing transmitters, particularly if there is no convenient line-of-sight (LOS) path to the sensing receiver for all reflection paths from all sensing transmitters. Each reflective path may have a different time-domain rotation coefficient to prevent interference with one another.

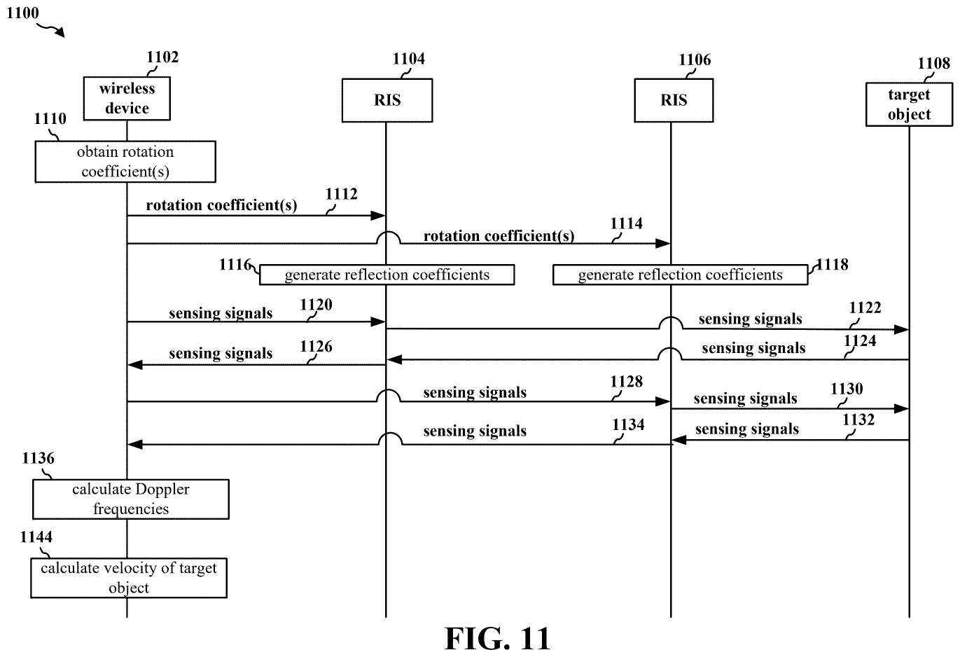

FIG. 11 is a connection flow diagram 1100 illustrating an example of communications between a wireless device 1102, a RIS 1104, and a RIS 1106 configured to sense a target object 1108 using monostatic sensing. The wireless device 1102 may be a network node or a UE. At 1110, the wireless device 1102 may obtain time-domain rotation coefficients for each of the reflection paths. In some aspects, the wireless device 1102 may configure the time-domain rotation coefficient itself, or may communicate with a sensing entity to obtain time-domain rotation coefficients from the sensing entity. The sensing may be performed using a first reflection path from the wireless device 1102, to the RIS 1104, to the target object 1108, back to the RIS 1104, and back to the wireless device 1102. The sensing may be performed using a second reflection path from the wireless device 1102, to the RIS 1106, to the target object 1108, back to the RIS 1106, and back to the wireless device 1102. The wireless device 1102 may transmit an indication of the set of rotation coefficients 1112 to the RIS 1104. The time-domain rotation coefficient may be associated with the first reflection path including the set of sensing signals 1120, the set of sensing signals 1122, the set of sensing signals 1124, and the set of sensing signals 1126. The RIS 1104 may receive the indication of the set of rotation coefficients 1112 from the wireless device 1102. The wireless device 1102 may transmit an indication of the time-domain rotation coefficient as the set of rotation coefficients 1114 to the RIS 1106. The set of rotation coefficients 1114 may be associated with the second reflection path including the set of sensing signals 1128, the set of sensing signals 1130, the set of sensing signals 1132, and the set of sensing signals 1134. The RIS 1106 may receive the indication of the time-domain rotation coefficient as the set of rotation coefficients 1114 from the wireless device 1102.

In some aspects, the wireless device 1102 may calculate each value

$${\{ {Δ}_{k} \}}_{k = 1}^{K}$$

for K reflection devices. For example, for two RISs, such as the RIS 1104 and the RIS 1106, the value of K may be 2. The wireless device 1102 may calculate

$${f}_{d , max} = \frac{{v}_{max}}{c} \cdot {f}_{c}$$

as the maximum value of the Doppler frequencies of all of the reflective device to target object 908 back to reflective device return paths, which may be determined by the maximum allowed moving velocity vₘₐₓ of the target object 1108. To make the Doppler spectrum of each reflective device and each sensing signal for a reflection path non-overlapping, the wireless device 1102 may be configured to ensure that the maximum measurable Doppler frequency satisfies

$${f}_{d , max , measure} = \frac{1}{T} \geq ( K + 1 ) \cdot 2 {f}_{d , max} .$$

To ensure that the Doppler spectrum of each reflective device starts at an integer index, Δ₀ may be set to

$$\frac{{f}_{d , max , measure}}{K + 1} = \frac{1}{( K + 1 ) T} .$$

As such, the wireless device 1102 may configure each reflective device k with

$${Δ}_{k} = k {Δ}_{0} = \frac{k}{( K + 1 ) T} .$$

In some aspects,

$${L}_{0} = \frac{L}{K + 1}$$

may be an integer.

At 1116, the RIS 1104 may generate a set of multiplicative factors of reflection coefficients for sensing signal reflection of the set of sensing signals 1120 at multiple periodical time occasions. The set of multiplicative factors may be calculated as e^{j2πΔ}^{₁}^{lT} for multiple periodical time occasions l=0~L−1, where Δ₁ is the set of rotation coefficients 1112 and T is an interval between the periodical time occasions. In other words, each multiplicative factor may be multiplied to the original reflection coefficient of each meta-element c_{k,l}, which may result in the reflection coefficients \tilde{c}_{k,l}=c_{k,l}e^{j2πΔ}^{ₖ}^{lT}. The wireless device 1102 may transmit the set of sensing signals 1120 based on the set of rotation coefficients 1112. The RIS 1104 may reflect the set of sensing signals 1120 based on the set of multiplicative factors of reflection coefficients based on the set of rotation coefficients 1112 as the set of sensing signals 1122. The set of sensing signals 1122 may reflect off of the target object 1108 as the set of sensing signals 1124. The RIS 1104 may reflect the set of sensing signals 1124 based on the set of multiplicative factors of reflection coefficients based on the set of rotation coefficients 1112 as the set of sensing signals 1126.

At 1118, the RIS 1106 may generate a set of multiplicative factors of reflection coefficients for sensing signal reflection of the set of sensing signals 1128 at multiple periodical time occasions. The set of multiplicative factors may be calculated as e^{j2πΔ}^{₂}^{lT} for multiple periodical time occasions l=0~L−1, where Δ₂ is the time-domain rotation coefficient of the set of rotation coefficients 1114 and T is an interval between the periodical time occasions. The wireless device 1102 may transmit the set of sensing signals 1128 based on the set of rotation coefficients 1114. The RIS 1106 may reflect the set of sensing signals 1128 based on the set of multiplicative factors of reflection coefficients based on the set of rotation coefficients 1114 as the set of sensing signals 1130. The set of sensing signals 1130 may reflect off of the target object 1108 as the set of sensing signals 1132. The RIS 1106 may reflect the set of sensing signals 1132 based on the set of multiplicative factors of reflection coefficients based on the set of rotation coefficients 1114 as the set of sensing signals 1134.

At 1136, the wireless device 1102 may calculate a first Doppler frequency based on the set of rotation coefficients 1112 associated with the first reflection path including the set of sensing signals 1120, the set of sensing signals 1122, the set of sensing signals 1124, and the set of sensing signals 1126. The wireless device 1102 may calculate a second Doppler frequency based on the set of rotation coefficients 1114 associated with the reflection path including the set of sensing signals 1128, the set of sensing signals 1130, the set of sensing signals 1132, and the set of sensing signals 1134.

In some aspects, the wireless device 1102 may estimate the Doppler frequency at each RIS's equivalent Doppler spectrum based on

$${\{ {Δ}_{k} \}}_{k = 1}^{K}$$

in which mutual interference is avoided. In other words, the wireless device 1102 may estimate the channel based on the transmitted and received sensing reference signal, resulting in an equivalent channel response h_{k,l}e^{-j2πΔ}^{ₖ}^{lT}, where h_{k,l} may be the original channel response at time occasion l. The wireless device 1102 may calculate the Doppler spectrum of the equivalent channel response of multiple occasions as \tilde{h}ₖ=[\tilde{h}_{k,0}, \tilde{h}_{k,1}, . . . , \tilde{h}_{k,L-1}]. Such an equivalent channel response may be a shifted version of the Doppler spectrum of the original channel response of multiple occasions hₖ=[h_{k,0}, h_{k,1}, . . . , h_{k,L-1}]. For example, the Doppler spectrums may be denoted as \tilde{H}ₖ=FFT (\tilde{h}ₖ), Hₖ=FFT (hₖ) which holds \tilde{H}ₖ(m)=Hₖ(mod(m+(k−1)L₀, L)). In other words, the equivalent Doppler spectrum of the kth RIS may be shifted right-ward with the length of kL₀. Because different RISs may have different shifting lengths, the equivalent Doppler spectrum may be non-overlapping, and thus when the RISs simultaneously reflect the sensing signals, the mutual interference in their Doppler spectrums may be avoided, as shown in FIGS. 8A and 8B.

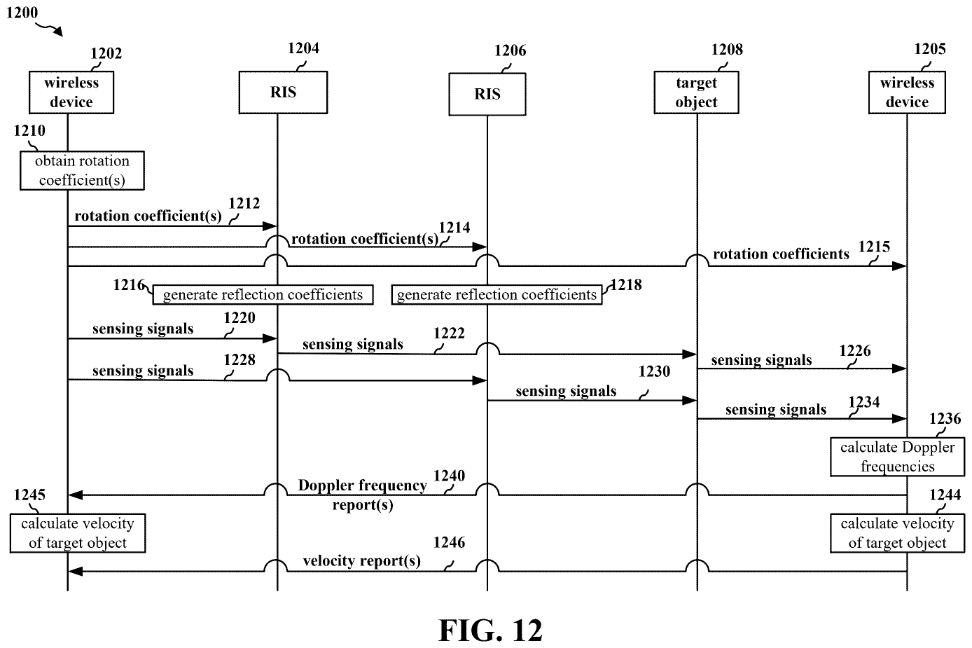

For a reflection path off of the target object 1108 without a RIS, no rotation factor may be used. The variable f_{d,0} for the reflection path without the RIS, may be estimated as \hat{f}_{d,0}=f_{d,0}. For the first reflection path off of the target object 1108 and the RIS 1104, the rotation factor e^{j2πΔ}^{₁}^{lT} may be used twice for monostatic sensing at the wireless device 1102 (otherwise, it may be used once for bistatic sensing at another wireless device, such as the wireless device 1205 in FIG. 12), thus the Doppler domain response (spectrum) may be shifted to a 2Δ₁ position (or Δ₁ for bistatic sensing). The variable f_{d,1} for the first reflection path off of the target object 1108 and the RIS 1104 may be estimated as \hat{f}_{d,1}=f_{d,1}−2Δ₁. For the second reflection path off of the target object 1108 and the RIS 1106, the rotation factor e^{j2πΔ}^{₁}^{lT} may be used twice for monostatic sensing at the wireless device 1102 (otherwise, it may be used once for bistatic sensing at another wireless device, such as the wireless device 1205 in FIG. 12), thus the Doppler domain response (spectrum) may be shifted to a 2Δ₂ position (or Δ₂ for bistatic sensing). The variable f_{d,2} for the first reflection path off of the target object 1108 and the RIS 1106 may be estimated as \hat{f}_{d,2}=f_{d,2}−2Δ₂. Thus, by utilizing rotation factors at the RIS 1104 and the RIS 1106, the Doppler spectrums of multiple paths (or the path without the RIS) may be separated into non-overlapping parts, which may improve the Doppler frequency and target object velocity estimation performance.

At 1144, the wireless device 1102 may calculate a velocity of the target object 1108 based on the calculated Doppler frequencies at 1136. In some aspects, the wireless device 1102 may transmit the calculated Doppler frequencies and/or the calculated velocity of the target object 1108 to a sensing entity.

While FIG. 11 illustrates a wireless device performing monostatic sensing on the target object 1108 using a pair of RISs, more than two RISs may be used to add additional paths to improve accuracy of the calculation at the wireless device 1102. In other aspects, more than two paths may be established between the wireless device 1102 and the target object 1108 with each RIS, for example a path may be established from the wireless device 1102 to the target object 1108 back to the RIS 1104 back to the wireless device 1102, or a path may be established from the wireless device 1102 to the RIS 1104 to the target object 1108 back to the wireless device 1102. In some aspects, a plurality of wireless devices may be used to perform monostatic sensing on the target object 1108 using at least one RIS to establish a reflective path for each of the plurality of wireless devices. Each reflective path may have a different time-domain rotation coefficient to prevent interference with one another. In some aspects, a plurality of wireless devices may be configured to perform bistatic sensing on the target object 1108 using one or more RIS devices to establish additional reflective paths.

FIG. 12 is a connection flow diagram 1200 illustrating an example of communications between a wireless device 1202, a wireless device 1205, a RIS 1204, and a RIS 1206 configured to sense a target object 1208 using bistatic sensing. The wireless device 1202 may be a network node or a UE. The wireless device 1202 may be a sensing transmitter. The wireless device 1205 may be a network node or a UE. The wireless device 1205 may be a sensing receiver. At 1210, the wireless device 1202 may obtain time-domain rotation coefficients for each of the reflection paths. In some aspects, the wireless device 1202 may configure the time-domain rotation coefficients itself, or may communicate with a sensing entity to obtain time-domain rotation coefficients from the sensing entity. The sensing may be performed using a first reflection path from the wireless device 1202, to the RIS 1204, to the target object 1208, and to the wireless device 1205. The sensing may be performed using a second reflection path from the wireless device 1202, to the RIS 1206, to the target object 1208, and to the wireless device 1205. The wireless device 1202 may transmit an indication of the time-domain rotation coefficient as the set of rotation coefficients 1212 to the RIS 1204. The time-domain rotation coefficient may be associated with the first reflection path including the set of sensing signals 1220, the set of sensing signals 1222, and the set of sensing signals 1226. The RIS 1204 may receive the indication of the time-domain rotation coefficient as the set of rotation coefficients 1212 from the wireless device 1202. The wireless device 1202 may transmit an indication of the time-domain rotation coefficient of the set of rotation coefficients 1214 to the RIS 1206. The set of rotation coefficients 1214 may be associated with the second reflection path including the set of sensing signals 1228, the set of sensing signals 1230, and the set of sensing signals 1234. The RIS 1206 may receive the indication of the time-domain rotation coefficient as the set of rotation coefficients 1214 from the wireless device 1202. The wireless device 1202 may transmit the set of rotation coefficients 1215 including the set of rotation coefficients 1212 and the set of rotation coefficients 1214 to the wireless device 1205. The wireless device 1205 may receive the set of rotation coefficients 1215 from the wireless device 1202.

At 1216, the RIS 1204 may generate a set of multiplicative factors of reflection coefficients for sensing signal reflection of the set of sensing signals 1220 at multiple periodical time occasions. The set of multiplicative factors may be calculated as e^{j2πΔ}^{₁}^{lT} for multiple periodical time occasions l=0~L−1, where Δ₁ is the time-domain rotation coefficient of the set of rotation coefficients 1212 and T is an interval between the periodical time occasions. The wireless device 1202 may transmit the set of sensing signals 1220 based on the set of rotation coefficients 1212. The RIS 1204 may reflect the set of sensing signals 1220 based on the set of multiplicative factors of reflection coefficients based on the set of rotation coefficients 1212 as the set of sensing signals 1222. The set of sensing signals 1222 may reflect off of the target object 1208 as the set of sensing signals 1226.

At 1218, the RIS 1206 may generate a set of multiplicative factors of reflection coefficients for sensing signal reflection of the set of sensing signals 1228 at multiple periodical time occasions. The set of multiplicative factors may be calculated as e^{j2πΔ}^{ₖ}^{lT} for multiple periodical time occasions l=0~L−1, where Δ₂ is the time-domain rotation coefficient of the set of rotation coefficients 1214 and T is an interval between the periodical time occasions. The wireless device 1202 may transmit the set of sensing signals 1228 based on the set of rotation coefficients 1214. The RIS 1206 may reflect the set of sensing signals 1228 based on the set of multiplicative factors of reflection coefficients based on the set of rotation coefficients 1214 as the set of sensing signals 1230. The set of sensing signals 1230 may reflect off of the target object 1208 as the set of sensing signals 1234.

At 1236, the wireless device 1205 may calculate a first Doppler frequency based on the set of rotation coefficients 1212 associated with the first reflection path including the set of sensing signals 1220, the set of sensing signals 1222, and the set of sensing signals 1226. The wireless device 1205 may calculate a second Doppler frequency based on the set of rotation coefficients 1214 associated with the reflection path including the set of sensing signals 1228, the set of sensing signals 1230, and the set of sensing signals 1234.

At 1244, the wireless device 1205 may calculate a velocity of the target object 1208 based on the calculated Doppler frequencies at 1236. The wireless device 1205 may transmit the set of velocity reports 1246 to the wireless device 1202 based on the velocity calculated at 1244 and/or the calculated Doppler frequencies at 1236. The wireless device 1202 may receive the set of velocity reports 1246 from the wireless device 1205.

In some aspects, the wireless device 1205 may transmit a set of Doppler frequency reports 1240 to the wireless device 1202 based on the first and second Doppler frequencies calculated at 1236. The wireless device 1202 may receive the set of Doppler frequency reports 1240 from the wireless device 1205. At 1245, the wireless device 1202 may calculate a velocity of the target object 1208 based on the received set of Doppler frequency reports 1240.

In some aspects, the wireless device 1202 may transmit the calculated Doppler frequencies and/or the calculated velocity of the target object 1208 to a sensing entity. In some aspects, the wireless device 1205 may transmit the calculated Doppler frequencies and/or the calculated velocity of the target object 1208 to a sensing entity.

While FIG. 12 illustrates wireless devices performing bistatic sensing on the target object 1208 using a pair of RISs, more than two RISs may be used to add additional paths to improve accuracy of the calculation at the wireless device 1205. In other aspects, more than two paths may be established between the wireless device 1202 and the target object 1208 with each RIS, for example a path may be established from the wireless device 1202 to the target object 1208 back to the RIS 1204 and to the wireless device 1205, or a path may be established from the wireless device 1202 to the RIS 1204 to the target object 1208 back to the RIS 1204, and to the wireless device 1205. In some aspects, a plurality of wireless devices may be used to act as sensing transmitters or as sensing receivers to perform sensing on the target object 1208 using at least one RIS to establish a reflective path for each of the plurality of wireless devices. Each reflective path may have a different time-domain rotation coefficient to prevent interference with one another.

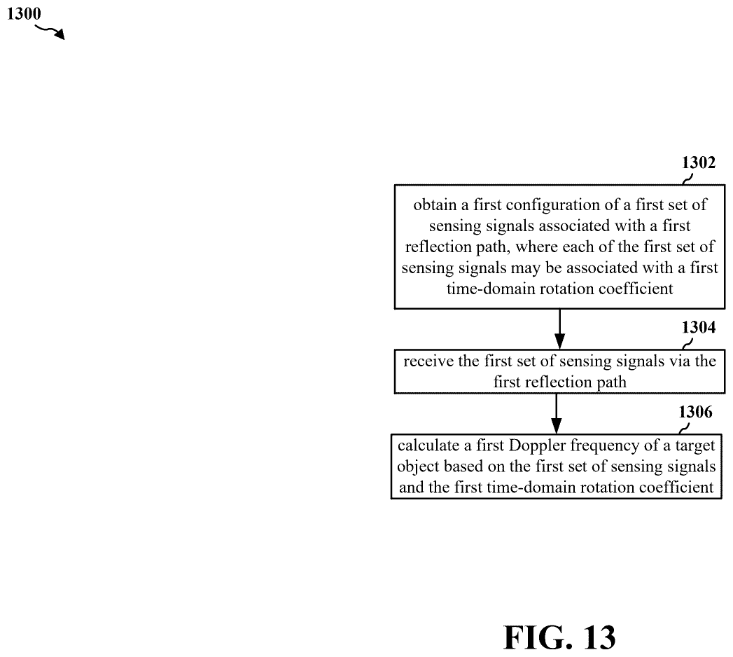

FIG. 13 is a flowchart 1300 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 704, the wireless device 706, the wireless device 708, the wireless device 904, the wireless device 906, the wireless device 1004, the wireless device 1005, the wireless device 1006, the wireless device 1102, the wireless device 1202; the RIS 604, the RIS 701, the RIS 703, the RIS 1104, the RIS 1106, the RIS 1204, the RIS 1206; the sensing entity 902, the sensing entity 1002; the apparatus 1904; the network entity 1902, the network entity 2002, the network entity 2160). At 1302, the wireless device may obtain a first configuration of a first set of sensing signals associated with a first reflection path. Each of the first set of sensing signals is associated with a first time-domain rotation coefficient. For example, 1302 may be performed by the wireless device 1102 in FIG. 11, which may, at 1110, obtain a first configuration of the set of sensing signals 1120 associated with a first reflection path including the set of sensing signals 1120, the set of sensing signals 1122, the set of sensing signals 1124, and the set of sensing signals 1126. The configuration may include the set of rotation coefficients 1112. Each of the set of sensing signals 1120 may be associated with the set of rotation coefficients 1112. Moreover, 1302 may be performed by the component 199 in FIG. 1, 3, 5, 19, 20, or 21.

At 1304, the wireless device may receive the first set of sensing signals via the first reflection path. For example, 1304 may be performed by the wireless device 1102 in FIG. 11, which may receive the set of sensing signals 1126 originating with the set of sensing signals 1120 via the first reflection path. Moreover, 1304 may be performed by the component 199 in FIG. 1, 3, 5, 19, 20, or 21.

At 1306, the wireless device may calculate a first Doppler frequency of a target object based on the first set of sensing signals and the first time-domain rotation coefficient. For example, 1306 may be performed by the wireless device 1102 in FIG. 11, which may, at 1136, calculate a first Doppler frequency of the target object 1108 based on the set of sensing signals 1126, which originated with the set of sensing signals 1120, and the set of rotation coefficients 1112. Moreover, 1306 may be performed by the component 199 in FIG. 1, 3, 5, 19, 20, or 21.

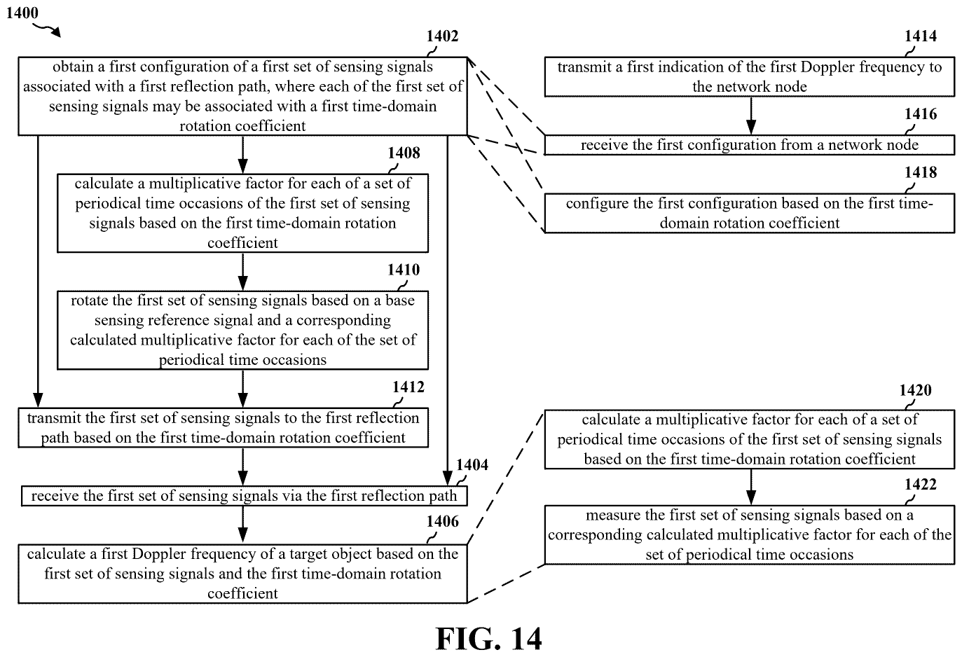

FIG. 14 is a flowchart 1400 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 704, the wireless device 706, the wireless device 708, the wireless device 904, the wireless device 906, the wireless device 1004, the wireless device 1005, the wireless device 1006, the wireless device 1102, the wireless device 1202; the RIS 604, the RIS 701, the RIS 703, the RIS 1104, the RIS 1106, the RIS 1204, the RIS 1206; the sensing entity 902, the sensing entity 1002; the apparatus 1904; the network entity 1902, the network entity 2002, the network entity 2160). At 1402, the wireless device may obtain a first configuration of a first set of sensing signals associated with a first reflection path. Each of the first set of sensing signals is associated with a first time-domain rotation coefficient. For example, 1402 may be performed by the wireless device 1102 in FIG. 11, which may, at 1110, obtain a first configuration of the set of sensing signals 1120 associated with a first reflection path including the set of sensing signals 1120, the set of sensing signals 1122, the set of sensing signals 1124, and the set of sensing signals 1126. Each of the set of sensing signals 1120 may be associated with the set of rotation coefficients 1112. Moreover, 1402 may be performed by the component 199 in FIG. 1, 3, 5, 19, 20, or 21.

At 1404, the wireless device may receive the first set of sensing signals via the first reflection path. For example, 1404 may be performed by the wireless device 1102 in FIG. 11, which may receive the set of sensing signals 1126 originating with the set of sensing signals 1120 via the first reflection path. Moreover, 1404 may be performed by the component 199 in FIG. 1, 3, 5, 19, 20, or 21.

At 1406, the wireless device may calculate a first Doppler frequency of a target object based on the first set of sensing signals and the first time-domain rotation coefficient. For example, 1406 may be performed by the wireless device 1102 in FIG. 11, which may, at 1136, calculate a first Doppler frequency of the target object 1108 based on the set of sensing signals 1126, which originated with the set of sensing signals 1120, and the set of rotation coefficients 1112. Moreover, 1406 may be performed by the component 199 in FIG. 1, 3, 5, 19, 20, or 21.

At 1408, the wireless device may calculate a multiplicative factor for each of a set of periodical time occasions of the first set of sensing signals based on the first time-domain rotation coefficient. For example, 1408 may be performed by the wireless device 904 in FIG. 9, which may, at 916, calculate a multiplicative factor for each of a set of periodical time occasions of the set of sensing signals 920 based on the first time-domain rotation coefficient of the set of rotation coefficients 912. In another aspect, 1408 may be performed by the wireless device 1004 in FIG. 10, which may, at 1016, calculate a multiplicative factor for each of a set of periodical time occasions of the set of sensing signals 1020 based on the first time-domain rotation coefficient of the set of rotation coefficients 1012. Moreover, 1408 may be performed by the component 199 in FIG. 1, 3, 5, 19, 20, or 21.

At 1410, the wireless device may rotate the first set of sensing signals based on a base sensing reference signal and a corresponding calculated multiplicative factor for each of the set of periodical time occasions. For example, 1410 may be performed by the wireless device 904 in FIG. 9, which may, at 916, rotate the set of sensing signals 920 based on a base sensing reference signal common to both the sensing signals 920 and the sensing signals 928 and a corresponding calculated multiplicative factor for each of the set of periodical time occasions for the set of sensing signals 920. In another example, 1410 may be performed by the wireless device 1004 in FIG. 10, which may, at 1016, rotate the set of sensing signals 1020 based on a base sensing reference signal common to both the sensing signals 1020 and the sensing signals 1028 and a corresponding calculated multiplicative factor for each of the set of periodical time occasions for the set of sensing signals 1020. Moreover, 1410 may be performed by the component 199 in FIG. 1, 3, 5, 19, 20, or 21.

At 1412, the wireless device may transmit the first set of sensing signals to the first reflection path based on the first time-domain rotation coefficient. For example, 1412 may be performed by the wireless device 1102 in FIG. 11, which may transmit the set of sensing signals 1120 along the first reflection path that includes the set of sensing signals 1120, the set of sensing signals 1122, the set of sensing signals 1124, and the set of sensing signals 1126, based on the first time-domain rotation coefficient, which may be in the set of rotation coefficients 1112. In another example, 1412 may be performed by the wireless device 904 in FIG. 9, which may transmit the set of sensing signals 920 along the first reflection path that includes the set of sensing signals 920, and the set of sensing signals 926, based on the first time-domain rotation coefficient, which may be in the set of rotation coefficients 912. Moreover, 1412 may be performed by the component 199 in FIG. 1, 3, 5, 19, 20, or 21.

At 1414, the wireless device may transmit a first indication of the first Doppler frequency to the network node. For example, 1414 may be performed by the wireless device 1102 in FIG. 11, which may transmit a first indication of the first Doppler frequency calculated at 1136 to a network node, such as a sensing entity. In another example, 1414 may be performed by the wireless device 904 in FIG. 9, which may transmit a first indication of the first Doppler frequency calculated at 936 to the sensing entity 902. Moreover, 1414 may be performed by the component 199 in FIG. 1, 3, 5, 19, 20, or 21.

At 1416, the wireless device may receive the first configuration from a network node. For example, 1416 may be performed by the wireless device 1102 in FIG. 11, which may, at 1110, receive the first configuration from a network node, such as a sensing entity. In another example, 1416 may be performed by the wireless device 904 in FIG. 9, which may receive the first configuration as the set of rotation coefficients 912 from the sensing entity 902. Moreover, 1416 may be performed by the component 199 in FIG. 1, 3, 5, 19, 20, or 21.

At 1418, the wireless device may configure the first configuration based on the first time-domain rotation coefficient. For example, 1418 may be performed by the wireless device 1102 in FIG. 11, which may, at 1110, configure the first configuration based on the first time-domain rotation coefficient. Moreover, 1418 may be performed by the component 199 in FIG. 1, 3, 5, 19, 20, or 21.

At 1420, the wireless device may calculate a multiplicative factor for each of a set of periodical time occasions of the first set of sensing signals based on the first time-domain rotation coefficient. For example, 1420 may be performed by the wireless device 904 in FIG. 9, which may, at 916, calculate a multiplicative factor for each of a set of periodical time occasions of the set of sensing signals 920 based on the first time-domain rotation coefficient. Moreover, 1420 may be performed by the component 199 in FIG. 1, 3, 5, 19, 20, or 21.

At 1422, the wireless device may measure the first set of sensing signals based on a corresponding calculated multiplicative factor for each of the set of periodical time occasions. For example, 1422 may be performed by the wireless device 904 in FIG. 9, which may, at 936, measure the set of sensing signals 926, which originated with the set of sensing signals 920, based on a corresponding calculated multiplicative factor for each of the set of periodical time occasions. Moreover, 1422 may be performed by the component 199 in FIG. 1, 3, 5, 19, 20, or 21.

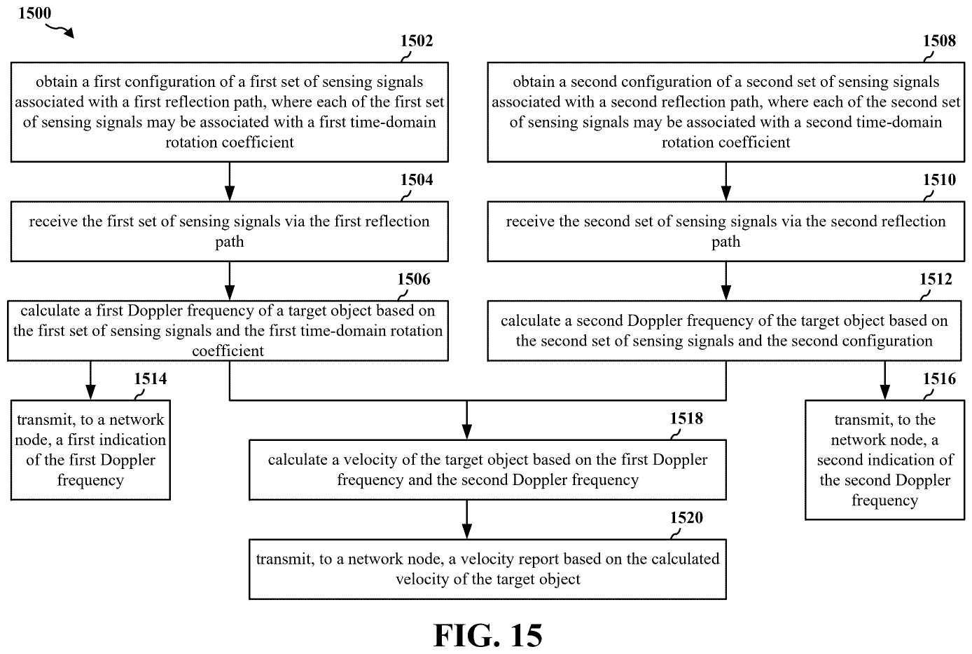

FIG. 15 is a flowchart 1500 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 704, the wireless device 706, the wireless device 708, the wireless device 904, the wireless device 906, the wireless device 1004, the wireless device 1005, the wireless device 1006, the wireless device 1102, the wireless device 1202; the RIS 604, the RIS 701, the RIS 703, the RIS 1104, the RIS 1106, the RIS 1204, the RIS 1206; the sensing entity 902, the sensing entity 1002; the apparatus 1904; the network entity 1902, the network entity 2002, the network entity 2160). At 1502, the wireless device may obtain a first configuration of a first set of sensing signals associated with a first reflection path. Each of the first set of sensing signals is associated with a first time-domain rotation coefficient. For example, 1502 may be performed by the wireless device 1102 in FIG. 11, which may, at 1110, obtain a first configuration of the set of sensing signals 1120 associated with a first reflection path including the set of sensing signals 1120, the set of sensing signals 1122, the set of sensing signals 1124, and the set of sensing signals 1126. Each of the set of sensing signals 1120 may be associated with the set of rotation coefficients 1112. In another example, 1502 may be performed by the wireless device 904 in FIG. 9, which may receive a first configuration as the set of rotation coefficients 912 of the set of sensing signals 920 associated with a first reflection path including the set of sensing signals 920, and the set of sensing signals 926. Each of the set of sensing signals 920 may be associated with a first rotation coefficient of the set of rotation coefficients 912. Moreover, 1502 may be performed by the component 199 in FIG. 1, 3, 5, 19, 20, or 21.

At 1504, the wireless device may receive the first set of sensing signals via the first reflection path. For example, 1504 may be performed by the wireless device 1102 in FIG. 11, which may receive the set of sensing signals 1126 originating with the set of sensing signals 1120 via the first reflection path. In another example, 1504 may be performed by the wireless device 904 in FIG. 9, which may receive the set of sensing signals 926 originating with the set of sensing signals 920 via the first reflection path. Moreover, 1504 may be performed by the component 199 in FIG. 1, 3, 5, 19, 20, or 21.

At 1506, the wireless device may calculate a first Doppler frequency of a target object based on the first set of sensing signals and the first time-domain rotation coefficient. For example, 1506 may be performed by the wireless device 1102 in FIG. 11, which may, at 1136, calculate a first Doppler frequency of the target object 1108 based on the set of sensing signals 1126, which originated with the set of sensing signals 1120, and the set of rotation coefficients 1112. In another example, 1506 may be performed by the wireless device 904 in FIG. 9, which may, at 936, calculate a first Doppler frequency of the target object 908 based on the set of sensing signals 926, which originated with the set of sensing signals 920, and the first rotation coefficient in the set of rotation coefficients 912. Moreover, 1506 may be performed by the component 199 in FIG. 1, 3, 5, 19, 20, or 21.

At 1508, the wireless device may obtain a second configuration of a second set of sensing signals associated with a second reflection path. Each of the second set of sensing signals may be associated with a second time-domain rotation coefficient. For example, 1508 may be performed by the wireless device 1102 in FIG. 11, which may, at 1110, obtain a second configuration of the set of sensing signals 1128 associated with a second reflection path including the set of sensing signals 1128, the set of sensing signals 1130, the set of sensing signals 1132, and the set of sensing signals 1134. Each of the set of sensing signals 1128 may be associated with a second time-domain rotation coefficient. In another example, 1508 may be performed by the wireless device 906 in FIG. 9, which may receive a second configuration as the set of rotation coefficients 914 of the set of sensing signals 928 associated with a second reflection path including the set of sensing signals 928, and the set of sensing signals 934. Each of the set of sensing signals 928 may be associated with a second time-domain rotation coefficient. Moreover, 1508 may be performed by the component 199 in FIG. 1, 3, 5, 19, 20, or 21.

At 1510, the wireless device may receive the second set of sensing signals via the second reflection path. For example, 1510 may be performed by the wireless device 1102 in FIG. 11, which may receive the set of sensing signals 1134, which originated with the set of sensing signals 1128, via the second reflection path. In another example, 1510 may be performed by the wireless device 906 in FIG. 9, which may receive the set of sensing signals 934, which originated with the set of sensing signals 928, via the second reflection path. Moreover, 1510 may be performed by the component 199 in FIG. 1, 3, 5, 19, 20, or 21.

At 1512, the wireless device may calculate a second Doppler frequency of the target object based on the second set of sensing signals and the second configuration. For example, 1512 may be performed by the wireless device 1102 in FIG. 11, which may, at 1136, calculate a second Doppler frequency of the target object 1108 based on the set of sensing signals 1134 and the second configuration that may include the set of rotation coefficients 1114. 1512 may be performed by the wireless device 906 in FIG. 9, which may, at 1138, calculate a second Doppler frequency of the target object 908 based on the set of sensing signals 934 and the second configuration that may include the set of rotation coefficients 914. Moreover, 1512 may be performed by the component 199 in FIG. 1, 3, 5, 19, 20, or 21.

At 1514, the wireless device may transmit, to a network node, a first indication of the first Doppler frequency. For example, 1514 may be performed by the wireless device 1102 in FIG. 11, which may transmit, to a network node, such as a sensing entity, a first indication of the first Doppler frequency calculated at 1136. In another example, 1514 may be performed by the wireless device 904 in FIG. 9, which may transmit, to the sensing entity 902, a first indication of the first Doppler frequency in the set of Doppler frequency reports 940, calculated at 936. Moreover, 1514 may be performed by the component 199 in FIG. 1, 3, 5, 19, 20, or 21.

At 1516, the wireless device may transmit, to the network node, a second indication of the second Doppler frequency. For example, 1516 may be performed by the wireless device 1102 in FIG. 11, which may transmit, to the network node, such as a sensing entity, a second indication of the second Doppler frequency calculated at 1136. In another example, 1516 may be performed by the wireless device 906 in FIG. 9, which may transmit, to the sensing entity 902, a second indication of the second Doppler frequency as the set of Doppler frequency reports 942 calculated at 938. Moreover, 1516 may be performed by the component 199 in FIG. 1, 3, 5, 19, 20, or 21.

At 1518, the wireless device may calculate a velocity of the target object based on the first Doppler frequency and the second Doppler frequency. For example, 1518 may be performed by the wireless device 1102 in FIG. 11, which may, at 1144, calculate a velocity of the target object 1108 based on the first Doppler frequency and the second Doppler frequency. In another aspect, 1518 may be performed by the sensing entity 902 in FIG. 9, which may, at 944, calculate a velocity of the target object 908 based on the first Doppler frequency and the second Doppler frequency. In some aspects, 1518 may be performed by the wireless device 904 in FIG. 9 if the wireless device 906 transmits the set of Doppler frequency reports 942 to the wireless device 904, or may be performed by the wireless device 906 in FIG. 9 if the wireless device 904 transmits the set of Doppler frequency reports 940 to the wireless device 906. Moreover, 1518 may be performed by the component 199 in FIG. 1, 3, 5, 19, 20, or 21.

At 1520, the wireless device may transmit, to a network node, a velocity report based on the calculated velocity of the target object. For example, 1520 may be performed by the wireless device 1102 in FIG. 11, which may transmit, to a network node, such as a sensing entity, a velocity report based on the velocity of the target object 1108 calculated at 1144. In another example, 1520 may be performed by the sensing entity 902 in FIG. 9, which may transmit, to a network node, a velocity report based on the velocity of the target object 908 calculated at 944. In some aspects, 1518 may be performed by the wireless device 904 in FIG. 9 if the wireless device 904 calculates the velocity of the target object 908 based on the Doppler frequencies calculated at 936 and at 938 (received as the set of Doppler frequency reports 942), or may be performed by the wireless device 906 in FIG. 9 if the wireless device 906 calculates the velocity of the target object 908 based on the Doppler frequencies calculated at 936 (received as the set of Doppler frequency reports 940) and at 938. Such a wireless device 904 or such a wireless device 906 may transmit the calculated velocity to the sensing entity 902. Moreover, 1520 may be performed by the component 199 in FIG. 1, 3, 5, 19, 20, or 21.

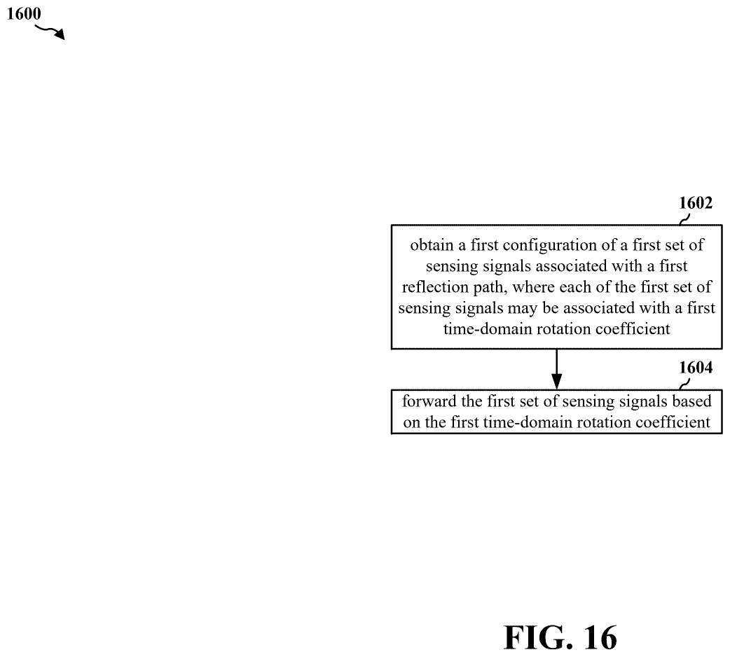

FIG. 16 is a flowchart 1600 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 704, the wireless device 706, the wireless device 708, the wireless device 904, the wireless device 906, the wireless device 1004, the wireless device 1006, the wireless device 1102, the wireless device 1202; the RIS 604, the RIS 701, the RIS 703, the RIS 1104, the RIS 1106, the RIS 1204, the RIS 1206; the sensing entity 902, the sensing entity 1002; the apparatus 1904; the network entity 1902, the network entity 2002, the network entity 2160). At 1602, the wireless device may obtain a first configuration of a first set of sensing signals associated with a first reflection path. Each of the first set of sensing signals may be associated with a first time-domain rotation coefficient. For example, 1602 may be performed by the RIS 1104 in FIG. 11, which may receive the set of rotation coefficients 1112 of the set of sensing signals 1120 associated with a first reflection path including the set of sensing signals 1120, the set of sensing signals 1122, the set of sensing signals 1124, and the set of sensing signals 1126. Each of the set of sensing signals 1120 may be associated with the set of rotation coefficients 1112. In another example, 1602 may be performed by the wireless device 904 in FIG. 9, which may receive, from the sensing entity 902, the set of rotation coefficients 912 of the set of sensing signals 920 associated with a first reflection path including the set of sensing signals 920, and the set of sensing signals 926. Each of the set of sensing signals 1120 may be associated with the set of rotation coefficients 912. In some aspects, the wireless device 904 may configure the set of rotation coefficients 912. Moreover, 1602 may be performed by the component 198 in FIG. 1, 3, 5, 19, 20, or 21.

At 1604, the wireless device may forward the first set of sensing signals based on the first time-domain rotation coefficient. For example, 1604 may be performed by the RIS 1104 in FIG. 11, which may reflect the set of sensing signals 1120 as the set of sensing signals 1122 based on the set of rotation coefficients 1112. In another example, 1604 may be performed by the wireless device 904 in FIG. 9, which may transmit the set of sensing signals 920 at the target object 908 based on the set of rotation coefficients 912. Moreover, 1604 may be performed by the component 198 in FIG. 1, 3, 5, 19, 20, or 21.

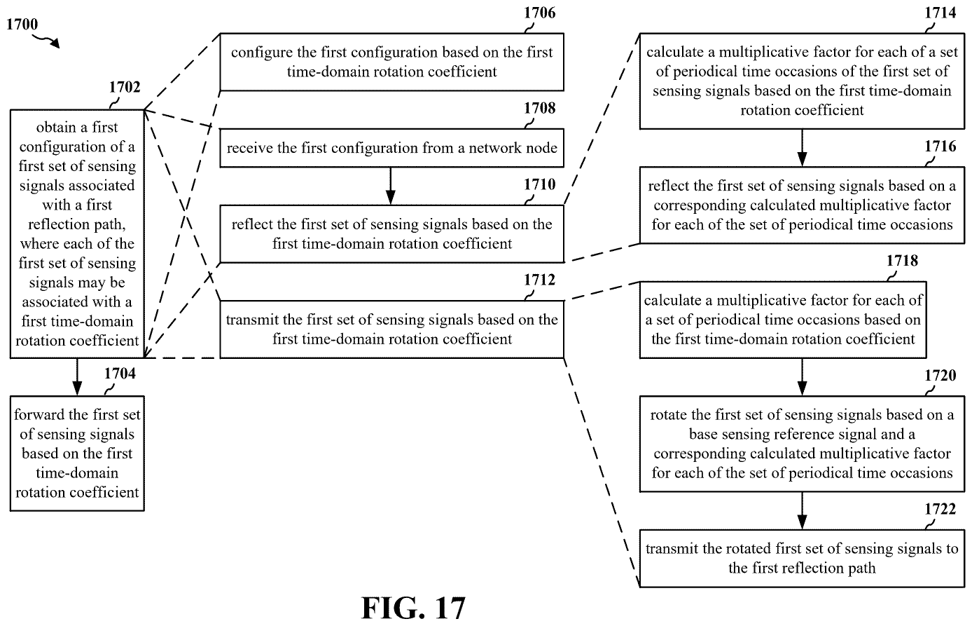

FIG. 17 is a flowchart 1700 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 704, the wireless device 706, the wireless device 708, the wireless device 904, the wireless device 906, the wireless device 1004, the wireless device 1006, the wireless device 1102, the wireless device 1202; the RIS 604, the RIS 701, the RIS 703, the RIS 1104, the RIS 1106, the RIS 1204, the RIS 1206; the sensing entity 902, the sensing entity 1002; the apparatus 1904; the network entity 1902, the network entity 2002, the network entity 2160). At 1702, the wireless device may obtain a first configuration of a first set of sensing signals associated with a first reflection path. Each of the first set of sensing signals may be associated with a first time-domain rotation coefficient. For example, 1702 may be performed by the RIS 1104 in FIG. 11, which may receive the set of rotation coefficients 1112 of the set of sensing signals 1120 associated with a first reflection path including the set of sensing signals 1120, the set of sensing signals 1122, the set of sensing signals 1124, and the set of sensing signals 1126. Each of the set of sensing signals 1120 may be associated with the set of rotation coefficients 1112. In another example, 1702 may be performed by the wireless device 904 in FIG. 9, which may receive, from the sensing entity 902, the set of rotation coefficients 912 of the set of sensing signals 920 associated with a first reflection path including the set of sensing signals 920, and the set of sensing signals 926. Each of the set of sensing signals 1120 may be associated with the set of rotation coefficients 912. In some aspects, the wireless device 904 may configure the set of rotation coefficients 912. Moreover, 1702 may be performed by the component 198 in FIG. 1, 3, 5, 19, 20, or 21.

At 1704, the wireless device may forward the first set of sensing signals based on the first time-domain rotation coefficient. For example, 1704 may be performed by the RIS 1104 in FIG. 11, which may reflect the set of sensing signals 1120 as the set of sensing signals 1122 based on the set of rotation coefficients 1112. In another example, 1704 may be performed by the wireless device 904 in FIG. 9, which may transmit the set of sensing signals 920 at the target object 908 based on the set of rotation coefficients 912. Moreover, 1704 may be performed by the component 198 in FIG. 1, 3, 5, 19, 20, or 21.

At 1706, the wireless device may configure the first configuration based on the first time-domain rotation coefficient. For example, 1706 may be performed by the RIS 1104 in FIG. 11, which may, at 1116, configure the first configuration based on the first time-domain rotation coefficient received in the set of rotation coefficients 1112. In another example, 1706 may be performed by the wireless device 904 in FIG. 9, which may, at 916, configure the first configuration based on the first time-domain rotation coefficient received in the set of rotation coefficients 912. Moreover, 1706 may be performed by the component 198 in FIG. 1, 3, 5, 19, 20, or 21.

At 1708, the wireless device may receive the first configuration from a network node. For example, 1708 may be performed by the RIS 1104 in FIG. 11, which may receive the first configuration from the wireless device 1102 as the set of rotation coefficients 1112. In another example, 1708 may be performed by the wireless device 904 in FIG. 9, which may receive the first configuration from the sensing entity 902 as the set of rotation coefficients 912. Moreover, 1708 may be performed by the component 198 in FIG. 1, 3, 5, 19, 20, or 21.

At 1710, the wireless device may reflect the first set of sensing signals based on the first time-domain rotation coefficient. For example, 1710 may be performed by the RIS 1104 in FIG. 11, which may reflect the set of sensing signals 1120 as the set of sensing signals 1122 based on the first time-domain rotation coefficient in the set of rotation coefficients 1112. Moreover, 1710 may be performed by the component 198 in FIG. 1, 3, 5, 19, 20, or 21.

At 1712, the wireless device may transmit the first set of sensing signals based on the first time-domain rotation coefficient. For example, 1712 may be performed by the wireless device 904 in FIG. 9, which may transmit the set of sensing signals 920 based on the set of rotation coefficients 912. Moreover, 1712 may be performed by the component 198 in FIG. 1, 3, 5, 19, 20, or 21.

At 1714, the wireless device may calculate a multiplicative factor for each of a set of periodical time occasions of the first set of sensing signals based on the first time-domain rotation coefficient. For example, 1714 may be performed by the RIS 1104 in FIG. 11, which may, at 1116, calculate a multiplicative factor for each of a set of periodical time occasions of the set of sensing signals 1120 based on the set of rotation coefficients 1112. Moreover, 1714 may be performed by the component 198 in FIG. 1, 3, 5, 19, 20, or 21.

At 1716, the wireless device may reflect the first set of sensing signals based on a corresponding calculated multiplicative factor for each of the set of periodical time occasions. For example, 1716 may be performed by the RIS 1104 in FIG. 11, which may reflect the set of sensing signals 1120 as the set of sensing signals 1122 based on a corresponding calculated multiplicative factor for each of the set of periodical time occasions. Moreover, 1716 may be performed by the component 198 in FIG. 1, 3, 5, 19, 20, or 21.

At 1718, the wireless device may calculate a multiplicative factor for each of a set of periodical time occasions based on the first time-domain rotation coefficient. For example, 1718 may be performed by the wireless device 904 in FIG. 9, which may, at 916, calculate a multiplicative factor for each of a set of periodical time occasions based on the set of rotation coefficients 912. Moreover, 1718 may be performed by the component 198 in FIG. 1, 3, 5, 19, 20, or 21.

At 1720, the wireless device may rotate the first set of sensing signals based on a base sensing reference signal and a corresponding calculated multiplicative factor for each of the set of periodical time occasions. For example, 1720 may be performed by the wireless device 904 in FIG. 9, which may rotate the set of sensing signals 920 based on a base sensing reference signal common to the set of sensing signals 920 and the set of sensing signals 928 and a corresponding calculated multiplicative factor for each of the set of periodical time occasions. Moreover, 1720 may be performed by the component 198 in FIG. 1, 3, 5, 19, 20, or 21.

At 1722, the wireless device may transmit the rotated first set of sensing signals to the first reflection path. For example, 1722 may be performed by the wireless device 904 in FIG. 9, which may transmit the rotated first set of sensing signals as the set of sensing signals 920 to the first reflection path that includes the set of sensing signals 920 and the set of sensing signals 926. Moreover, 1722 may be performed by the component 198 in FIG. 1, 3, 5, 19, 20, or 21.

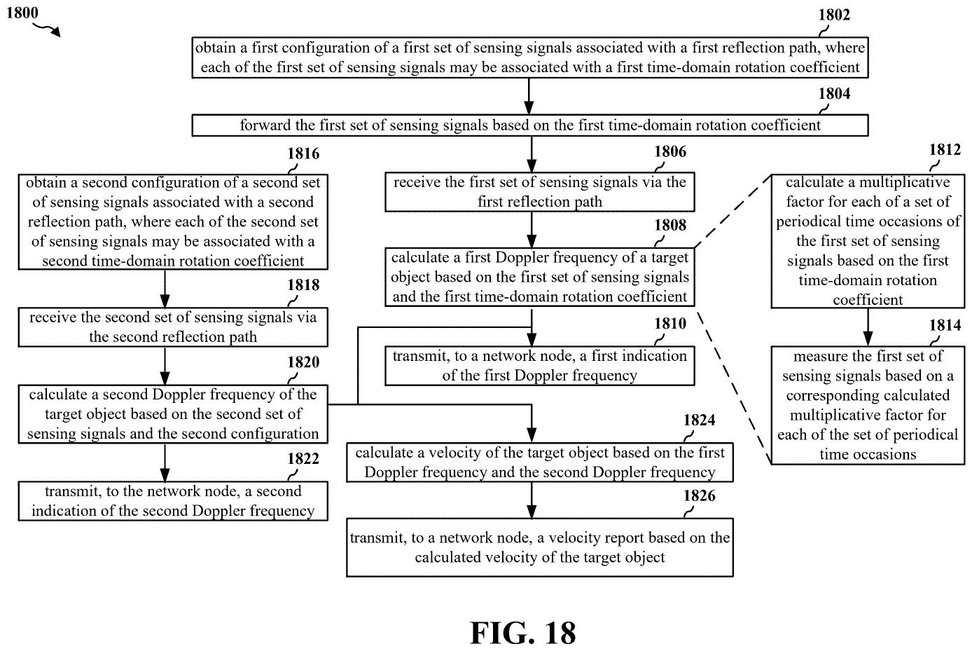

FIG. 18 is a flowchart 1800 of a method of wireless communication. The method may be performed by a wireless device (e.g., the UE 104, the UE 350, the UE 404; the base station 102, the base station 310; the wireless device 502, the wireless device 504, the wireless device 506, the wireless device 508, the wireless device 602, the wireless device 606, the wireless device 702, the wireless device 704, the wireless device 706, the wireless device 708, the wireless device 904, the wireless device 906, the wireless device 1004, the wireless device 1006, the wireless device 1102, the wireless device 1202; the RIS 604, the RIS 701, the RIS 703, the RIS 1104, the RIS 1106, the RIS 1204, the RIS 1206; the sensing entity 902, the sensing entity 1002; the apparatus 1904; the network entity 1902, the network entity 2002, the network entity 2160). At 1802, the wireless device may obtain a first configuration of a first set of sensing signals associated with a first reflection path. Each of the first set of sensing signals may be associated with a first time-domain rotation coefficient. For example, 1802 may be performed by the RIS 1104 in FIG. 11, which may receive the set of rotation coefficients 1112 of the set of sensing signals 1120 associated with a first reflection path including the set of sensing signals 1120, the set of sensing signals 1122, the set of sensing signals 1124, and the set of sensing signals 1126. Each of the set of sensing signals 1120 may be associated with the set of rotation coefficients 1112. In another example, 1802 may be performed by the wireless device 904 in FIG. 9, which may receive, from the sensing entity 902, the set of rotation coefficients 912 of the set of sensing signals 920 associated with a first reflection path including the set of sensing signals 920, and the set of sensing signals 926. Each of the set of sensing signals 1120 may be associated with the set of rotation coefficients 912. In some aspects, the wireless device 904 may configure the set of rotation coefficients 912. Moreover, 1802 may be performed by the component 198 in FIG. 1, 3, 5, 19, 20, or 21.

At 1804, the wireless device may forward the first set of sensing signals based on the first time-domain rotation coefficient. For example, 1804 may be performed by the RIS 1104 in FIG. 11, which may reflect the set of sensing signals 1120 as the set of sensing signals 1122 based on the set of rotation coefficients 1112. In another example, 1804 may be performed by the wireless device 904 in FIG. 9, which may transmit the set of sensing signals 920 at the target object 908 based on the set of rotation coefficients 912. Moreover, 1804 may be performed by the component 198 in FIG. 1, 3, 5, 19, 20, or 21.

At 1806, the wireless device may receive the first set of sensing signals via the first reflection path. For example, 1806 may be performed by the wireless device 904 in FIG. 9, which may receive the set of sensing signals 926, which originated with the set of sensing signals 920, via the first reflection path. Moreover, 1806 may be performed by the component 198 in FIG. 1, 3, 5, 19, 20, or 21.

At 1808, the wireless device may calculate a first Doppler frequency of a target object based on the first set of sensing signals and the first time-domain rotation coefficient. For example, 1808 may be performed by the wireless device 904 in FIG. 9, which may, at 936, calculate a first Doppler frequency of the target object 908 based on the set of sensing signals 934 and the set of rotation coefficients 912. Moreover, 1808 may be performed by the component 198 in FIG. 1, 3, 5, 19, 20, or 21.

At 1810, the wireless device may transmit, to a network node, a first indication of the first Doppler frequency. For example, 1810 may be performed by the wireless device 904 in FIG. 9, which may transmit, to the sensing entity 902, a first indication of the first Doppler frequency in the set of Doppler frequency reports 940. Moreover, 1810 may be performed by the component 198 in FIG. 1, 3, 5, 19, 20, or 21.

At 1812, the wireless device may calculate a multiplicative factor for each of a set of periodical time occasions of the first set of sensing signals based on the first time-domain rotation coefficient. For example, 1812 may be performed by the wireless device 904 in FIG. 9, which may, at 916, calculate a multiplicative factor for each of a set of periodical time occasions of the set of sensing signals 920 based on the set of rotation coefficients 912. Moreover, 1812 may be performed by the component 198 in FIG. 1, 3, 5, 19, 20, or 21.

At 1814, the wireless device may measure the first set of sensing signals based on a corresponding calculated multiplicative factor for each of the set of periodical time occasions. For example, 1814 may be performed by the wireless device 904 in FIG. 9, which may, at 936, measure the set of sensing signals 926 based on a corresponding calculated multiplicative factor for each of the set of periodical time occasions. Moreover, 1814 may be performed by the component 198 in FIG. 1, 3, 5, 19, 20, or 21.

At 1816, the wireless device may obtain a second configuration of a second set of sensing signals associated with a second reflection path. Each of the second set of sensing signals may be associated with a second time-domain rotation coefficient. For example, 1816 may be performed by the wireless device 906 in FIG. 9, which may receive a second configuration of the set of sensing signals 928 as the set of rotation coefficients 914 associated with a second reflection path that includes the set of sensing signals 928 and the set of sensing signals 934. Each of the set of sensing signals 928 may be associated with a second time-domain rotation coefficient. Moreover, 1816 may be performed by the component 198 in FIG. 1, 3, 5, 19, 20, or 21.

At 1818, the wireless device may receive the second set of sensing signals via the second reflection path. For example, 1818 may be performed by the wireless device 906 in FIG. 9, which may receive the set of sensing signals 934, which originate with the set of sensing signals 928, via the second reflection path. Moreover, 1818 may be performed by the component 198 in FIG. 1, 3, 5, 19, 20, or 21.

At 1820, the wireless device may calculate a second Doppler frequency of the target object based on the second set of sensing signals and the second configuration. For example, 1820 may be performed by the wireless device 906 in FIG. 9, which may, at 938, calculate a second Doppler frequency of the target object 908 based on the set of sensing signals 928 and the second configuration that includes the set of rotation coefficients 914. Moreover, 1820 may be performed by the component 198 in FIG. 1, 3, 5, 19, 20, or 21.

At 1822, the wireless device may calculate a velocity of the target object based on the first Doppler frequency and the second Doppler frequency. For example, 1822 may be performed by the sensing entity 902 in FIG. 9, which may, at 944, calculate a velocity of the target object 908 object based on the first Doppler frequency and the second Doppler frequency. In some aspects, the wireless device 904 may calculate the velocity of the target object 908 based on the first Doppler frequency and the second Doppler frequency if the wireless device 906 is configured to transmit the set of Doppler frequency reports 942 to the wireless device 904, or the wireless device 906 may calculate the velocity of the target object 908 based on the first Doppler frequency and the second Doppler frequency if the wireless device 904 is configured to transmit the set of Doppler frequency reports 940 to the wireless device 906. Moreover, 1822 may be performed by the component 198 in FIG. 1, 3, 5, 19, 20, or 21.

At 1824, the wireless device may transmit, to the network node, a second indication of the second Doppler frequency. For example, 1824 may be performed by the wireless device 906 in FIG. 9, which may transmit, to the sensing entity 902, a second indication of the second Doppler frequency as the set of Doppler frequency reports 942. Moreover, 1824 may be performed by the component 198 in FIG. 1, 3, 5, 19, 20, or 21.

At 1826, the wireless device may transmit, to a network node, a velocity report based on the calculated velocity of the target object. For example, 1826 may be performed by the sensing entity 902 in FIG. 9, which may transmit, to a network node, a velocity report based on the calculated velocity of the target object 908 calculated at 944. In another example, 1826 may be performed by the wireless device 904 in FIG. 9, which may transmit, to the sensing entity 902, a velocity report as a set of velocity reports based on the calculated velocity of the target object 908 if the wireless device 904 is configured to calculate the velocity of the target object 908 based on the first Doppler frequency calculated at 936 and the second Doppler frequency calculated at 938, or may be performed by the wireless device 906 in FIG. 9, which may transmit, to the sensing entity 902, a velocity report as a set of velocity reports based on the calculated velocity of the target object 908 if the wireless device 906 is configured to calculate the velocity of the target object 908 based on the first Doppler frequency calculated at 936 and the second Doppler frequency calculated at 938. Moreover, 1826 may be performed by the component 198 in FIG. 1, 3, 5, 19, 20, or 21.

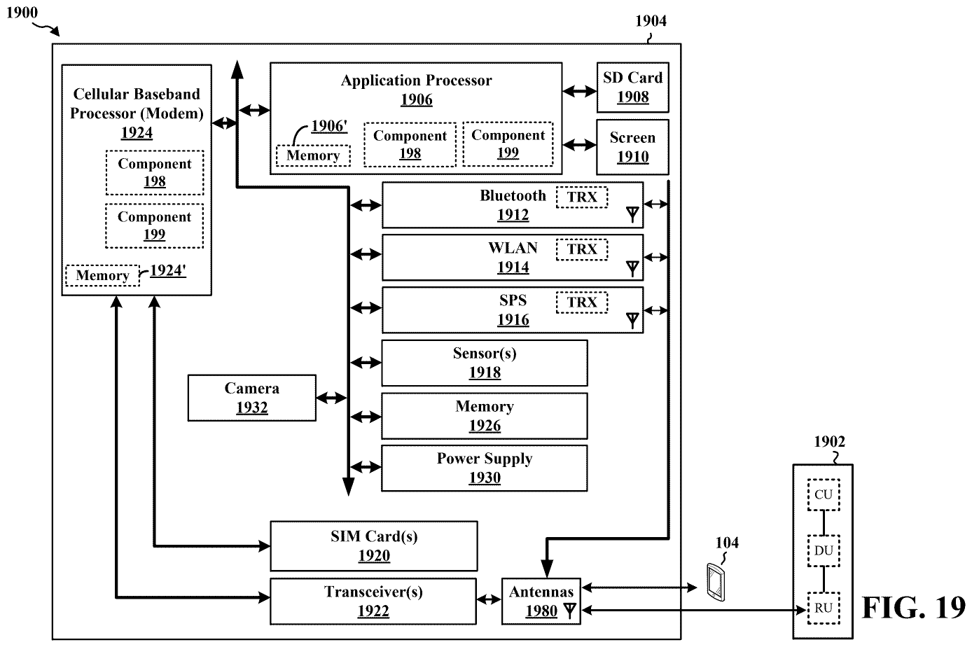

FIG. 19 is a diagram 1900 illustrating an example of a hardware implementation for an apparatus 1904. The apparatus 1904 may be a UE, a component of a UE, or may implement UE functionality. In some aspects, the apparatus 1204 may include a cellular baseband processor 1924 (also referred to as a modem) coupled to one or more transceivers 1922 (e.g., cellular RF transceiver). The cellular baseband processor 1924 may include on-chip memory 1924′. In some aspects, the apparatus 1904 may further include one or more subscriber identity modules (SIM) cards 1920 and an application processor 1906 coupled to a secure digital (SD) card 1908 and a screen 1910. The application processor 1906 may include on-chip memory 1906′. In some aspects, the apparatus 1904 may further include a Bluetooth module 1912, a WLAN module 1914, an SPS module 1916 (e.g., GNSS module), one or more sensor modules 1918 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1926, a power supply 1930, and/or a camera 1932. The Bluetooth module 1912, the WLAN module 1914, and the SPS module 1916 may include an on-chip transceiver (TRX) (or in some cases, just a receiver (RX)). The Bluetooth module 1912, the WLAN module 1914, and the SPS module 1916 may include their own dedicated antennas and/or utilize the antennas 1980 for communication. The cellular baseband processor 1924 communicates through the transceiver(s) 1922 via one or more antennas 1980 with the UE 104 and/or with an RU associated with a network entity 1902. The cellular baseband processor 1924 and the application processor 1906 may each include a computer-readable medium/memory 1924′, 1906′, respectively. The additional memory modules 1926 may also be considered a computer-readable medium/memory. Each computer-readable medium/memory 1924′, 1906′, 1926 may be non-transitory. The cellular baseband processor 1924 and the application processor 1906 are each responsible for general processing, including the execution of software stored on the computer-readable medium/memory. The software, when executed by the cellular baseband processor 1924/application processor 1906, causes the cellular baseband processor 1924/application processor 1906 to perform the various functions described supra. The computer-readable medium/memory may also be used for storing data that is manipulated by the cellular baseband processor 1924/application processor 1906 when executing software. The cellular baseband processor 1924/application processor 1906 may be a component of the UE 350 and may include the memory 360 and/or at least one of the TX processor 368, the RX processor 356, and the controller/processor 359. In one configuration, the apparatus 1904 may be a processor chip (modem and/or application) and include just the cellular baseband processor 1924 and/or the application processor 1906, and in another configuration, the apparatus 1904 may be the entire UE (e.g., see UE 350 of FIG. 3) and include the additional modules of the apparatus 1904.

As discussed supra, the component 198 may be configured to obtain a first configuration of a first set of sensing signals associated with a first reflection path. Each of the first set of sensing signals may be associated with a first time-domain rotation coefficient. The component 198 may be configured to receive the first set of sensing signals via the first reflection path. The component 198 may be configured to calculate a first Doppler frequency of a target object based on the first set of sensing signals and the first time-domain rotation coefficient. The component 198 may be within the cellular baseband processor 1924, the application processor 1906, or both the cellular baseband processor 1924 and the application processor 1906. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, may include means for obtaining a first configuration of a first set of sensing signals associated with a first reflection path. Each of the first set of sensing signals may be associated with a first time-domain rotation coefficient. The apparatus 1904 may include means for receiving the first set of sensing signals via the first reflection path. The apparatus 1904 may include means for calculating a first Doppler frequency of a target object based on the first set of sensing signals and the first time-domain rotation coefficient. The apparatus 1904 may include means for calculating a multiplicative factor for each of a set of periodical time occasions of the first set of sensing signals based on the first time-domain rotation coefficient. The apparatus 1904 may include means for measuring the first set of sensing signals based on a corresponding calculated multiplicative factor for each of the first set of periodical time occasions. The apparatus 1904 may include means for obtaining the first configuration by receiving the first configuration from a network node. The apparatus 1904 may include means for transmitting a first indication of the first Doppler frequency to the network node. The network node may include a sensing management entity. The apparatus 1904 may include means for obtaining a second configuration of a second set of sensing signals associated with a second reflection path. Each of the second set of sensing signals may be associated with a second time-domain rotation coefficient. The apparatus 1904 may include means for receiving the second set of sensing signals via the second reflection path. The apparatus 1904 may include means for calculating a second Doppler frequency of the target object based on the second set of sensing signals and the second configuration. The apparatus 1904 may include means for transmitting, to a network node, a first indication of the first Doppler frequency. The apparatus 1904 may include means for transmitting, to the network node, a second indication of the second Doppler frequency. The apparatus 1904 may include means for calculating a velocity of the target object based on the first Doppler frequency and the second Doppler frequency. The apparatus 1904 may include means for transmitting, to a network node, a velocity report based on the calculated velocity of the target object. The apparatus 1904 may include means for transmitting the first set of sensing signals to the first reflection path based on the first time-domain rotation coefficient. The apparatus 1904 may include means for transmitting the first set of sensing signals by calculating a multiplicative factor for each of a set of periodical time occasions of the first set of sensing signals based on the first time-domain rotation coefficient. The apparatus 1904 may include means for transmitting the first set of sensing signals by rotating the first set of sensing signals based on a base sensing reference signal and a corresponding calculated multiplicative factor for each of the set of periodical time occasions. The apparatus 1904 may include means for transmitting the first set of sensing signals by transmitting the rotated first set of sensing signals to the first reflection path. The apparatus 1904 may include means for obtaining the first configuration by configuring the first configuration based on the first time-domain rotation coefficient. The wireless device may include at least one of a network node or a UE. The means may be the component 198 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

As discussed supra, the component 199 may be configured to obtain a first configuration of a first set of sensing signals associated with a first reflection path. Each of the first set of sensing signals may be associated with a first time-domain rotation coefficient. The component 199 may forward the first set of sensing signals based on the first time-domain rotation coefficient. The time-domain rotation coefficient may be used to generate a multiplicative factor used to rotate the sensing signal relative to other sensing signals, allowing a wireless device that receives the sensing signal to measure the sensing signal without interference from other simultaneously transmitted sensing signals. The component 199 may be within the cellular baseband processor 1924, the application processor 1906, or both the cellular baseband processor 1924 and the application processor 1906. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1904 may include a variety of components configured for various functions. In one configuration, the apparatus 1904, and in particular the cellular baseband processor 1924 and/or the application processor 1906, may include means for obtaining a first configuration of a first set of sensing signals associated with a first reflection path. Each of the first set of sensing signals may include associated with a first time-domain rotation coefficient. The apparatus 1904 may include means for forwarding the first set of sensing signals based on the first time-domain rotation coefficient. The apparatus 1904 may include means for obtaining the first configuration by receiving the first configuration from a network node. The apparatus 1904 may include means for forwarding the first set of sensing signals by reflecting the first set of sensing signals based on the first time-domain rotation coefficient. The apparatus 1904 may include means for reflecting the first set of sensing signals by calculating a multiplicative factor for each of a set of periodical time occasions of the first set of sensing signals based on the first time-domain rotation coefficient. The apparatus 1904 may include means for reflecting the first set of sensing signals by reflecting the first set of sensing signals based on a corresponding calculated multiplicative factor for each of the set of periodical time occasions. The wireless device may include a RIS. The network node may include a sensing management entity. The apparatus 1904 may include means for receiving a second configuration of a second set of sensing signals associated with a second reflection path. Each of the second set of sensing signals may be associated with a second time-domain rotation coefficient. The apparatus 1904 may include means for reflecting the second set of sensing signals based on the second time-domain rotation coefficient. The first reflection path and the second reflection path may include a target object. The apparatus 1904 may include means for forwarding the first set of sensing signals by transmitting the first set of sensing signals based on the first time-domain rotation coefficient. The apparatus 1904 may include means for transmitting the first set of sensing signals by calculating a multiplicative factor for each of a set of periodical time occasions based on the first time-domain rotation coefficient. The apparatus 1904 may include means for transmitting the first set of sensing signals by rotating the first set of sensing signals based on a base sensing reference signal and a corresponding calculated multiplicative factor for each of the set of periodical time occasions. The apparatus 1904 may include means for transmitting the first set of sensing signals by transmitting the rotated first set of sensing signals to the first reflection path. The apparatus 1904 may include means for obtaining the first configuration by receiving the first configuration from a network node. The apparatus 1904 may include means for obtaining the first configuration by configuring the first configuration based on the first time-domain rotation coefficient. The apparatus 1904 may include means for obtaining a second configuration of a second set of sensing signals associated with a second reflection path. Each of the second set of sensing signals is associated with a second time-domain rotation coefficient. The apparatus 1904 may include means for forwarding the second set of sensing signals based on the second time-domain rotation coefficient. The first reflection path and the second reflection path may include a target object. The apparatus 1904 may include means for receiving the first set of sensing signals via the first reflection path. The apparatus 1904 may include means for calculating a first Doppler frequency of a target object based on the first set of sensing signals and the first time-domain rotation coefficient. The apparatus 1904 may include means for calculating the first Doppler frequency of the target object by calculating a multiplicative factor for each of a set of periodical time occasions of the first set of sensing signals based on the first time-domain rotation coefficient. The apparatus 1904 may include means for calculating the first Doppler frequency of the target object by measuring the first set of sensing signals based on a corresponding calculated multiplicative factor for each of the set of periodical time occasions. The apparatus 1904 may include means for obtaining the first configuration by receiving the first configuration from a network node. The apparatus 1904 may include means for transmitting, to the network node, a first indication of the first Doppler frequency. The apparatus 1904 may include means for obtaining a second configuration of a second set of sensing signals associated with a second reflection path. Each of the second set of sensing signals may be associated with a second time-domain rotation coefficient. The apparatus 1904 may include means for receiving the second set of sensing signals via the second reflection path. The apparatus 1904 may include means for calculating a second Doppler frequency of the target object based on the second set of sensing signals and the second configuration. The apparatus 1904 may include means for transmitting, to a network node, a first indication of the first Doppler frequency. The apparatus 1904 may include means for transmitting, to the network node, a second indication of the second Doppler frequency. The apparatus 1904 may include means for calculating a velocity of the target object based on the first Doppler frequency and the second Doppler frequency. The apparatus 1904 may include means for transmitting, to a network node, a velocity report based on the calculated velocity of the target object. The means may be the component 199 of the apparatus 1904 configured to perform the functions recited by the means. As described supra, the apparatus 1904 may include the TX processor 368, the RX processor 356, and the controller/processor 359. As such, in one configuration, the means may be the TX processor 368, the RX processor 356, and/or the controller/processor 359 configured to perform the functions recited by the means.

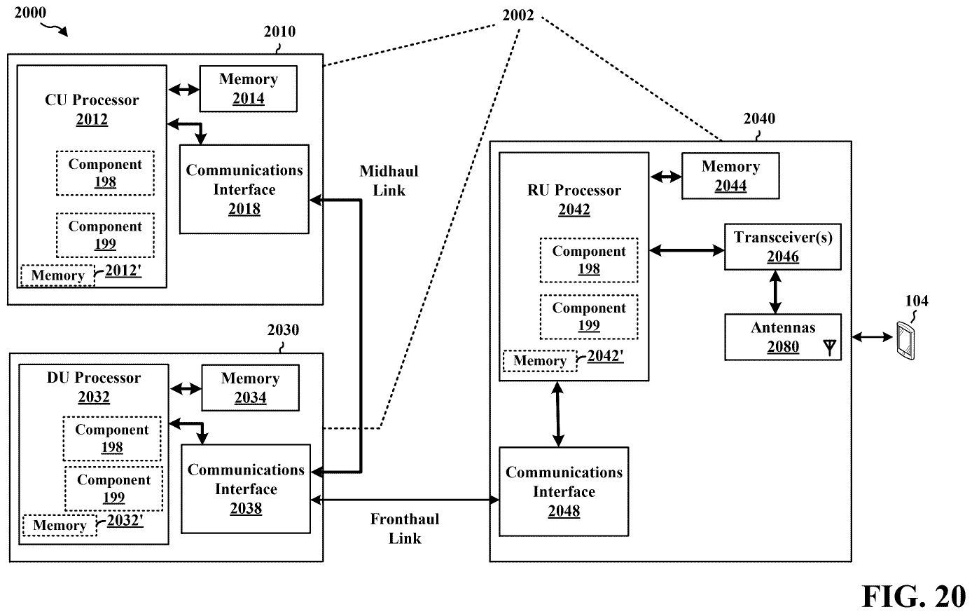

FIG. 20 is a diagram 2000 illustrating an example of a hardware implementation for a network entity 2002. The network entity 2002 may be a BS, a component of a BS, or may implement BS functionality. The network entity 2002 may include at least one of a CU 2010, a DU 2030, or an RU 2040. For example, depending on the layer functionality handled by the component 199, the network entity 2002 may include the CU 2010; both the CU 2010 and the DU 2030; each of the CU 2010, the DU 2030, and the RU 2040; the DU 2030; both the DU 2030 and the RU 2040; or the RU 2040. The CU 2010 may include a CU processor 2012. The CU processor 2012 may include on-chip memory 2012′. In some aspects, the CU 2010 may further include additional memory modules 2014 and a communications interface 2018. The CU 2010 communicates with the DU 2030 through a midhaul link, such as an F1 interface. The DU 2030 may include a DU processor 2032. The DU processor 2032 may include on-chip memory 2032′. In some aspects, the DU 2030 may further include additional memory modules 2034 and a communications interface 2038. The DU 2030 communicates with the RU 2040 through a fronthaul link. The RU 2040 may include an RU processor 2042. The RU processor 2042 may include on-chip memory 2042′. In some aspects, the RU 2040 may further include additional memory modules 2044, one or more transceivers 2046, antennas 2080, and a communications interface 2048. The RU 2040 communicates with the UE 104. The on-chip memory 2012′, 2032′, 2042′ and the additional memory modules 2014, 2034, 2044 may each be considered a computer-readable medium/memory. Each computer-readable medium/memory may be non-transitory. Each of the processors 2012, 2032, 2042 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to obtain a first configuration of a first set of sensing signals associated with a first reflection path. Each of the first set of sensing signals may be associated with a first time-domain rotation coefficient. The component 198 may be configured to receive the first set of sensing signals via the first reflection path. The component 198 may be configured to calculate a first Doppler frequency of a target object based on the first set of sensing signals and the first time-domain rotation coefficient. The component 198 may be within one or more processors of one or more of the CU 2010, DU 2030, and the RU 2040. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 may include means for obtaining a first configuration of a first set of sensing signals associated with a first reflection path. Each of the first set of sensing signals may be associated with a first time-domain rotation coefficient. The network entity 2002 may include means for receiving the first set of sensing signals via the first reflection path. The network entity 2002 may include means for calculating a first Doppler frequency of a target object based on the first set of sensing signals and the first time-domain rotation coefficient. The network entity 2002 may include means for calculating a multiplicative factor for each of a set of periodical time occasions of the first set of sensing signals based on the first time-domain rotation coefficient. The network entity 2002 may include means for measuring the first set of sensing signals based on a corresponding calculated multiplicative factor for each of the first set of periodical time occasions. The network entity 2002 may include means for obtaining the first configuration by receiving the first configuration from a network node. The network entity 2002 may include means for transmitting a first indication of the first Doppler frequency to the network node. The network node may include a sensing management entity. The network entity 2002 may include means for obtaining a second configuration of a second set of sensing signals associated with a second reflection path. Each of the second set of sensing signals may be associated with a second time-domain rotation coefficient. The network entity 2002 may include means for receiving the second set of sensing signals via the second reflection path. The network entity 2002 may include means for calculating a second Doppler frequency of the target object based on the second set of sensing signals and the second configuration. The network entity 2002 may include means for transmitting, to a network node, a first indication of the first Doppler frequency. The network entity 2002 may include means for transmitting, to the network node, a second indication of the second Doppler frequency. The network entity 2002 may include means for calculating a velocity of the target object based on the first Doppler frequency and the second Doppler frequency. The network entity 2002 may include means for transmitting, to a network node, a velocity report based on the calculated velocity of the target object. The network entity 2002 may include means for transmitting the first set of sensing signals to the first reflection path based on the first time-domain rotation coefficient. The network entity 2002 may include means for transmitting the first set of sensing signals by calculating a multiplicative factor for each of a set of periodical time occasions of the first set of sensing signals based on the first time-domain rotation coefficient. The network entity 2002 may include means for transmitting the first set of sensing signals by rotating the first set of sensing signals based on a base sensing reference signal and a corresponding calculated multiplicative factor for each of the set of periodical time occasions. The network entity 2002 may include means for transmitting the first set of sensing signals by transmitting the rotated first set of sensing signals to the first reflection path. The network entity 2002 may include means for obtaining the first configuration by configuring the first configuration based on the first time-domain rotation coefficient. The wireless device may include at least one of a network node or a UE. The means may be the component 198 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to obtain a first configuration of a first set of sensing signals associated with a first reflection path. Each of the first set of sensing signals may be associated with a first time-domain rotation coefficient. The component 199 may forward the first set of sensing signals based on the first time-domain rotation coefficient. The time-domain rotation coefficient may be used to generate a multiplicative factor used to rotate the sensing signal relative to other sensing signals, allowing a wireless device that receives the sensing signal to measure the sensing signal without interference from other simultaneously transmitted sensing signals. The component 199 may be within one or more processors of one or more of the CU 2010, DU 2030, and the RU 2040. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2002 may include a variety of components configured for various functions. In one configuration, the network entity 2002 may include means for obtaining a first configuration of a first set of sensing signals associated with a first reflection path. Each of the first set of sensing signals may include associated with a first time-domain rotation coefficient. The network entity 2002 may include means for forwarding the first set of sensing signals based on the first time-domain rotation coefficient. The network entity 2002 may include means for obtaining the first configuration by receiving the first configuration from a network node. The network entity 2002 may include means for forwarding the first set of sensing signals by reflecting the first set of sensing signals based on the first time-domain rotation coefficient. The network entity 2002 may include means for reflecting the first set of sensing signals by calculating a multiplicative factor for each of a set of periodical time occasions of the first set of sensing signals based on the first time-domain rotation coefficient. The network entity 2002 may include means for reflecting the first set of sensing signals by reflecting the first set of sensing signals based on a corresponding calculated multiplicative factor for each of the set of periodical time occasions. The wireless device may include a RIS. The network node may include a sensing management entity. The network entity 2002 may include means for receiving a second configuration of a second set of sensing signals associated with a second reflection path. Each of the second set of sensing signals may be associated with a second time-domain rotation coefficient. The network entity 2002 may include means for reflecting the second set of sensing signals based on the second time-domain rotation coefficient. The first reflection path and the second reflection path may include a target object. The network entity 2002 may include means for forwarding the first set of sensing signals by transmitting the first set of sensing signals based on the first time-domain rotation coefficient. The network entity 2002 may include means for transmitting the first set of sensing signals by calculating a multiplicative factor for each of a set of periodical time occasions based on the first time-domain rotation coefficient. The network entity 2002 may include means for transmitting the first set of sensing signals by rotating the first set of sensing signals based on a base sensing reference signal and a corresponding calculated multiplicative factor for each of the set of periodical time occasions. The network entity 2002 may include means for transmitting the first set of sensing signals by transmitting the rotated first set of sensing signals to the first reflection path. The network entity 2002 may include means for obtaining the first configuration by receiving the first configuration from a network node. The network entity 2002 may include means for obtaining the first configuration by configuring the first configuration based on the first time-domain rotation coefficient. The network entity 2002 may include means for obtaining a second configuration of a second set of sensing signals associated with a second reflection path. Each of the second set of sensing signals is associated with a second time-domain rotation coefficient. The network entity 2002 may include means for forwarding the second set of sensing signals based on the second time-domain rotation coefficient. The first reflection path and the second reflection path may include a target object. The network entity 2002 may include means for receiving the first set of sensing signals via the first reflection path. The network entity 2002 may include means for calculating a first Doppler frequency of a target object based on the first set of sensing signals and the first time-domain rotation coefficient. The network entity 2002 may include means for calculating the first Doppler frequency of the target object by calculating a multiplicative factor for each of a set of periodical time occasions of the first set of sensing signals based on the first time-domain rotation coefficient. The network entity 2002 may include means for calculating the first Doppler frequency of the target object by measuring the first set of sensing signals based on a corresponding calculated multiplicative factor for each of the set of periodical time occasions. The network entity 2002 may include means for obtaining the first configuration by receiving the first configuration from a network node. The network entity 2002 may include means for transmitting, to the network node, a first indication of the first Doppler frequency. The network entity 2002 may include means for obtaining a second configuration of a second set of sensing signals associated with a second reflection path. Each of the second set of sensing signals may be associated with a second time-domain rotation coefficient. The network entity 2002 may include means for receiving the second set of sensing signals via the second reflection path. The network entity 2002 may include means for calculating a second Doppler frequency of the target object based on the second set of sensing signals and the second configuration. The network entity 2002 may include means for transmitting, to a network node, a first indication of the first Doppler frequency. The network entity 2002 may include means for transmitting, to the network node, a second indication of the second Doppler frequency. The network entity 2002 may include means for calculating a velocity of the target object based on the first Doppler frequency and the second Doppler frequency. The network entity 2002 may include means for transmitting, to a network node, a velocity report based on the calculated velocity of the target object. The means may be the component 199 of the network entity 2002 configured to perform the functions recited by the means. As described supra, the network entity 2002 may include the TX processor 316, the RX processor 370, and the controller/processor 375. As such, in one configuration, the means may be the TX processor 316, the RX processor 370, and/or the controller/processor 375 configured to perform the functions recited by the means.

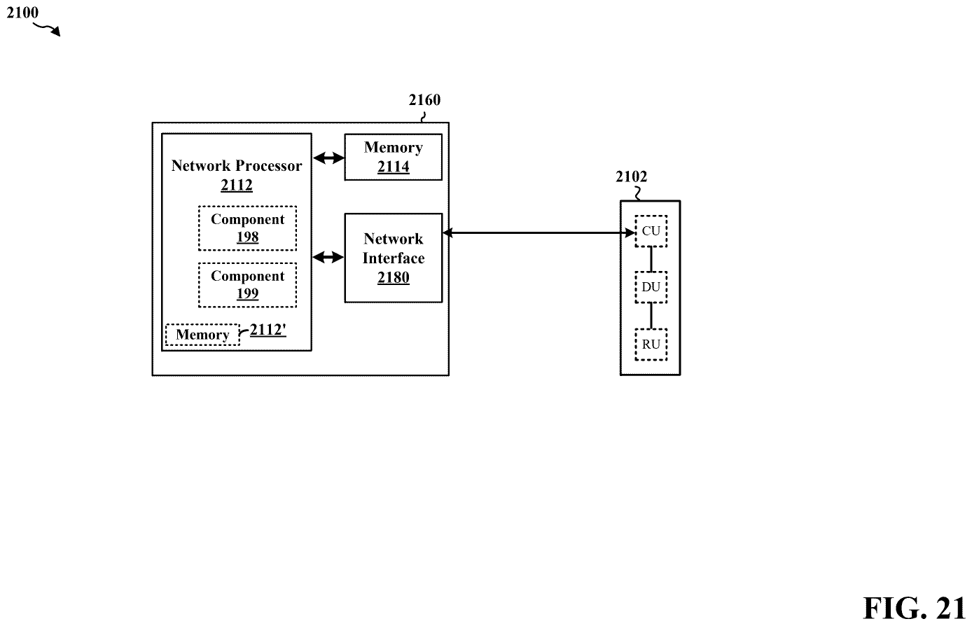

FIG. 21 is a diagram 2100 illustrating an example of a hardware implementation for a network entity 2160. In one example, the network entity 2160 may be within the core network 120. The network entity 2160 may include a network processor 2112. The network processor 2112 may include on-chip memory 2112′. In some aspects, the network entity 2160 may further include additional memory modules 2114. The network entity 2160 communicates via the network interface 2180 directly (e.g., backhaul link) or indirectly (e.g., through a RIC) with the CU 2102. The on-chip memory 2112′ and the additional memory modules 2114 may each be considered a computer-readable medium/memory. Each computer-readable medium/memory may be non-transitory. The processor 2112 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to obtain a first configuration of a first set of sensing signals associated with a first reflection path. Each of the first set of sensing signals may be associated with a first time-domain rotation coefficient. The component 198 may be configured to receive the first set of sensing signals via the first reflection path. The component 198 may be configured to calculate a first Doppler frequency of a target object based on the first set of sensing signals and the first time-domain rotation coefficient. The component 198 may be within the processor 2112. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2160 may include a variety of components configured for various functions. In one configuration, the network entity 2160 may include means for obtaining a first configuration of a first set of sensing signals associated with a first reflection path. Each of the first set of sensing signals may be associated with a first time-domain rotation coefficient. The network entity 2160 may include means for receiving the first set of sensing signals via the first reflection path. The network entity 2160 may include means for calculating a first Doppler frequency of a target object based on the first set of sensing signals and the first time-domain rotation coefficient. The network entity 2160 may include means for calculating a multiplicative factor for each of a set of periodical time occasions of the first set of sensing signals based on the first time-domain rotation coefficient. The network entity 2160 may include means for measuring the first set of sensing signals based on a corresponding calculated multiplicative factor for each of the first set of periodical time occasions. The network entity 2160 may include means for obtaining the first configuration by receiving the first configuration from a network node. The network entity 2160 may include means for transmitting a first indication of the first Doppler frequency to the network node. The network node may include a sensing management entity. The network entity 2160 may include means for obtaining a second configuration of a second set of sensing signals associated with a second reflection path. Each of the second set of sensing signals may be associated with a second time-domain rotation coefficient. The network entity 2160 may include means for receiving the second set of sensing signals via the second reflection path. The network entity 2160 may include means for calculating a second Doppler frequency of the target object based on the second set of sensing signals and the second configuration. The network entity 2160 may include means for transmitting, to a network node, a first indication of the first Doppler frequency. The network entity 2160 may include means for transmitting, to the network node, a second indication of the second Doppler frequency. The network entity 2160 may include means for calculating a velocity of the target object based on the first Doppler frequency and the second Doppler frequency. The network entity 2160 may include means for transmitting, to a network node, a velocity report based on the calculated velocity of the target object. The network entity 2160 may include means for transmitting the first set of sensing signals to the first reflection path based on the first time-domain rotation coefficient. The network entity 2160 may include means for transmitting the first set of sensing signals by calculating a multiplicative factor for each of a set of periodical time occasions of the first set of sensing signals based on the first time-domain rotation coefficient. The network entity 2160 may include means for transmitting the first set of sensing signals by rotating the first set of sensing signals based on a base sensing reference signal and a corresponding calculated multiplicative factor for each of the set of periodical time occasions. The network entity 2160 may include means for transmitting the first set of sensing signals by transmitting the rotated first set of sensing signals to the first reflection path. The network entity 2160 may include means for obtaining the first configuration by configuring the first configuration based on the first time-domain rotation coefficient. The wireless device may include at least one of a network node or a UE. The means may be the component 198 of the network entity 2160 configured to perform the functions recited by the means.

As discussed supra, the component 199 may be configured to obtain a first configuration of a first set of sensing signals associated with a first reflection path. Each of the first set of sensing signals may be associated with a first time-domain rotation coefficient. The component 199 may forward the first set of sensing signals based on the first time-domain rotation coefficient. The time-domain rotation coefficient may be used to generate a multiplicative factor used to rotate the sensing signal relative to other sensing signals, allowing a wireless device that receives the sensing signal to measure the sensing signal without interference from other simultaneously transmitted sensing signals. The component 199 may be within the processor 2112. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 2160 may include a variety of components configured for various functions. In one configuration, the network entity 2160 may include means for obtaining a first configuration of a first set of sensing signals associated with a first reflection path. Each of the first set of sensing signals may include associated with a first time-domain rotation coefficient. The network entity 2160 may include means for forwarding the first set of sensing signals based on the first time-domain rotation coefficient. The network entity 2160 may include means for obtaining the first configuration by receiving the first configuration from a network node. The network entity 2160 may include means for forwarding the first set of sensing signals by reflecting the first set of sensing signals based on the first time-domain rotation coefficient. The network entity 2160 may include means for reflecting the first set of sensing signals by calculating a multiplicative factor for each of a set of periodical time occasions of the first set of sensing signals based on the first time-domain rotation coefficient. The network entity 2160 may include means for reflecting the first set of sensing signals by reflecting the first set of sensing signals based on a corresponding calculated multiplicative factor for each of the set of periodical time occasions. The wireless device may include a RIS. The network node may include a sensing management entity. The network entity 2160 may include means for receiving a second configuration of a second set of sensing signals associated with a second reflection path. Each of the second set of sensing signals may be associated with a second time-domain rotation coefficient. The network entity 2160 may include means for reflecting the second set of sensing signals based on the second time-domain rotation coefficient. The first reflection path and the second reflection path may include a target object. The network entity 2160 may include means for forwarding the first set of sensing signals by transmitting the first set of sensing signals based on the first time-domain rotation coefficient. The network entity 2160 may include means for transmitting the first set of sensing signals by calculating a multiplicative factor for each of a set of periodical time occasions based on the first time-domain rotation coefficient. The network entity 2160 may include means for transmitting the first set of sensing signals by rotating the first set of sensing signals based on a base sensing reference signal and a corresponding calculated multiplicative factor for each of the set of periodical time occasions. The network entity 2160 may include means for transmitting the first set of sensing signals by transmitting the rotated first set of sensing signals to the first reflection path. The network entity 2160 may include means for obtaining the first configuration by receiving the first configuration from a network node. The network entity 2160 may include means for obtaining the first configuration by configuring the first configuration based on the first time-domain rotation coefficient. The network entity 2160 may include means for obtaining a second configuration of a second set of sensing signals associated with a second reflection path. Each of the second set of sensing signals is associated with a second time-domain rotation coefficient. The network entity 2160 may include means for forwarding the second set of sensing signals based on the second time-domain rotation coefficient. The first reflection path and the second reflection path may include a target object. The network entity 2160 may include means for receiving the first set of sensing signals via the first reflection path. The network entity 2160 may include means for calculating a first Doppler frequency of a target object based on the first set of sensing signals and the first time-domain rotation coefficient. The network entity 2160 may include means for calculating the first Doppler frequency of the target object by calculating a multiplicative factor for each of a set of periodical time occasions of the first set of sensing signals based on the first time-domain rotation coefficient. The network entity 2160 may include means for calculating the first Doppler frequency of the target object by measuring the first set of sensing signals based on a corresponding calculated multiplicative factor for each of the set of periodical time occasions. The network entity 2160 may include means for obtaining the first configuration by receiving the first configuration from a network node. The network entity 2160 may include means for transmitting, to the network node, a first indication of the first Doppler frequency. The network entity 2160 may include means for obtaining a second configuration of a second set of sensing signals associated with a second reflection path. Each of the second set of sensing signals may be associated with a second time-domain rotation coefficient. The network entity 2160 may include means for receiving the second set of sensing signals via the second reflection path. The network entity 2160 may include means for calculating a second Doppler frequency of the target object based on the second set of sensing signals and the second configuration. The network entity 2160 may include means for transmitting, to a network node, a first indication of the first Doppler frequency. The network entity 2160 may include means for transmitting, to the network node, a second indication of the second Doppler frequency. The network entity 2160 may include means for calculating a velocity of the target object based on the first Doppler frequency and the second Doppler frequency. The network entity 2160 may include means for transmitting, to a network node, a velocity report based on the calculated velocity of the target object. The means may be the component 199 of the network entity 2160 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive the data, for example with a transceiver, or may obtain the data from a device that receives the data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a wireless device, where the method may include obtaining a first configuration of a first set of sensing signals associated with a first reflection path. Each of the first set of sensing signals may be associated with a first time-domain rotation coefficient. The method may include receiving the first set of sensing signals via the first reflection path. The method may include calculating a first Doppler frequency of a target object based on the first set of sensing signals and the first time-domain rotation coefficient.

Aspect 2 is the method of aspect 1, where the method may include calculating a multiplicative factor for each of a set of periodical time occasions of the first set of sensing signals based on the first time-domain rotation coefficient. The method may include measuring the first set of sensing signals based on a corresponding calculated multiplicative factor for each of the first set of periodical time occasions.

Aspect 3 is the method of either of aspects 1 or 2, where obtaining the first configuration may include receiving the first configuration from a network node.

Aspect 4 is the method aspect 3, where the method may include transmitting a first indication of the first Doppler frequency to the network node.

Aspect 5 is the method of aspect 4, where the network node may include a sensing management entity.

Aspect 6 is the method of any of aspects 1 to 5, where the method may include obtaining a second configuration of a second set of sensing signals associated with a second reflection path. Each of the second set of sensing signals may be associated with a second time-domain rotation coefficient. The method may include receiving the second set of sensing signals via the second reflection path. The method may include calculating a second Doppler frequency of the target object based on the second set of sensing signals and the second configuration.

Aspect 7 is the method of aspect 6, where the method may include transmitting, to a network node, a first indication of the first Doppler frequency. The method may include transmitting, to the network node, a second indication of the second Doppler frequency.

Aspect 8 is the method of any of aspects 1 to 7, where the method may include calculating a velocity of the target object based on the first Doppler frequency and the second Doppler frequency. The method may include transmitting, to a network node, a velocity report based on the calculated velocity of the target object.

Aspect 9 is the method of any of aspects 1 to 8, where the method may include transmitting the first set of sensing signals to the first reflection path based on the first time-domain rotation coefficient.

Aspect 10 is the method of aspect 9, where transmitting the first set of sensing signals may include calculating a multiplicative factor for each of a set of periodical time occasions of the first set of sensing signals based on the first time-domain rotation coefficient. Transmitting the first set of sensing signals may include rotating the first set of sensing signals based on a base sensing reference signal and a corresponding calculated multiplicative factor for each of the set of periodical time occasions. Transmitting the first set of sensing signals may include transmitting the rotated first set of sensing signals to the first reflection path.

Aspect 11 is the method of either of aspects 9 or 10, where obtaining the first configuration may include configuring the first configuration based on the first time-domain rotation coefficient.

Aspect 12 is the method of any of aspects 1 to 11, where the wireless device may include at least one of a network node or a UE.

Aspect 13 is a method of wireless communication at a wireless device, where the method may include obtaining a first configuration of a first set of sensing signals associated with a first reflection path. Each of the first set of sensing signals may include associated with a first time-domain rotation coefficient. The method may include forwarding the first set of sensing signals based on the first time-domain rotation coefficient.

Aspect 14 is the method of aspect 13, where obtaining the first configuration may include receiving the first configuration from a network node. Forwarding the first set of sensing signals may include reflecting the first set of sensing signals based on the first time-domain rotation coefficient.

Aspect 15 is the method of aspect 14, where reflecting the first set of sensing signals may include calculating a multiplicative factor for each of a set of periodical time occasions of the first set of sensing signals based on the first time-domain rotation coefficient. Reflecting the first set of sensing signals may include reflecting the first set of sensing signals based on a corresponding calculated multiplicative factor for each of the set of periodical time occasions.

Aspect 16 is the method of either of aspects 14 or 15, where the wireless device may include a RIS.

Aspect 17 is the method of any of aspects 14 to 16, where the network node may include a sensing management entity.

Aspect 18 is the method of any of aspects 14 to 17, where the method may include receiving a second configuration of a second set of sensing signals associated with a second reflection path. Each of the second set of sensing signals may be associated with a second time-domain rotation coefficient. The method may include reflecting the second set of sensing signals based on the second time-domain rotation coefficient. The first reflection path and the second reflection path may include a target object.

Aspect 19 is the method of any of aspects 13 to 18, where forwarding the first set of sensing signals may include transmitting the first set of sensing signals based on the first time-domain rotation coefficient.

Aspect 20 is the method of aspect 19, where transmitting the first set of sensing signals may include calculating a multiplicative factor for each of a set of periodical time occasions based on the first time-domain rotation coefficient. Transmitting the first set of sensing signals may include rotating the first set of sensing signals based on a base sensing reference signal and a corresponding calculated multiplicative factor for each of the set of periodical time occasions. Transmitting the first set of sensing signals may include transmitting the rotated first set of sensing signals to the first reflection path.

Aspect 21 is the method of either of aspects 19 or 20, where obtaining the first configuration may include receiving the first configuration from a network node.

Aspect 22 is the method of any of aspects 19 to 21, where obtaining the first configuration may include configuring the first configuration based on the first time-domain rotation coefficient.

Aspect 23 is the method of any of aspects 13 to 22, where the method may include obtaining a second configuration of a second set of sensing signals associated with a second reflection path. Each of the second set of sensing signals is associated with a second time-domain rotation coefficient. The method may include forwarding the second set of sensing signals based on the second time-domain rotation coefficient. The first reflection path and the second reflection path may include a target object.

Aspect 24 is the method of any of aspects 13 to 23, where the method may include receiving the first set of sensing signals via the first reflection path. The method may include calculating a first Doppler frequency of a target object based on the first set of sensing signals and the first time-domain rotation coefficient.

Aspect 25 is the method of aspect 24, where calculating the first Doppler frequency of the target object may include calculating a multiplicative factor for each of a set of periodical time occasions of the first set of sensing signals based on the first time-domain rotation coefficient. Calculating the first Doppler frequency of the target object may include measuring the first set of sensing signals based on a corresponding calculated multiplicative factor for each of the set of periodical time occasions.

Aspect 26 is the method of either of aspects 24 or 25, where obtaining the first configuration may include receiving the first configuration from a network node.

Aspect 27 is the method of aspect 26, where the method may include transmitting, to the network node, a first indication of the first Doppler frequency.

Aspect 28 is the method of any of aspects 24 to 27, where the method may include obtaining a second configuration of a second set of sensing signals associated with a second reflection path. Each of the second set of sensing signals may be associated with a second time-domain rotation coefficient. The method may include receiving the second set of sensing signals via the second reflection path. The method may include calculating a second Doppler frequency of the target object based on the second set of sensing signals and the second configuration.

Aspect 29 is the method of any of aspects 13 to 28, where the method may include transmitting, to a network node, a first indication of the first Doppler frequency. The method may include transmitting, to the network node, a second indication of the second Doppler frequency.

Aspect 30 is the method of any of aspects 13 to 29, where the method may include calculating a velocity of the target object based on the first Doppler frequency and the second Doppler frequency. The method may include transmitting, to a network node, a velocity report based on the calculated velocity of the target object.

Aspect 31 is an apparatus for wireless communication, including: a memory; and at least one processor coupled to the memory and, based at least in part on information stored in the memory, the at least one processor is configured to implement any of aspects 1 to 30.

Aspect 32 is the apparatus of aspect 31, further including at least one of an antenna or a transceiver coupled to the at least one processor.

Aspect 33 is an apparatus for wireless communication including means for implementing any of aspects 1 to 30.

Aspect 34 is a computer-readable medium (e.g., a non-transitory computer-readable medium) storing computer executable code, where the code when executed by a processor causes the processor to implement any of aspects 1 to 30.

1. An apparatus for wireless communication at a wireless device, comprising:
memory; and
at least one processor coupled to the memory and, based at least in part on information stored in the memory, the at least one processor is configured to:
obtain a first configuration of a first set of sensing signals associated with a first reflection path, wherein each of the first set of sensing signals is associated with a first time-domain rotation coefficient;
receive the first set of sensing signals via the first reflection path; and
calculate a first Doppler frequency of a target object based on the first set of sensing signals and the first time-domain rotation coefficient.

2. The apparatus of claim 1, wherein, to calculate the first Doppler frequency of the target object, the at least one processor is configured to:
calculate a multiplicative factor for each of a set of periodical time occasions of the first set of sensing signals based on the first time-domain rotation coefficient; and
measure the first set of sensing signals based on a corresponding calculated multiplicative factor for each of the set of periodical time occasions.

3. (canceled)

4. The apparatus of claim 1, wherein the at least one processor is further configured to:
transmit a first indication of the first Doppler frequency to a network node.

5. (canceled)

6. The apparatus of claim 1, wherein the at least one processor is further configured to:
obtain a second configuration of a second set of sensing signals associated with a second reflection path, wherein each of the second set of sensing signals is associated with a second time-domain rotation coefficient;
receive the second set of sensing signals via the second reflection path; and
calculate a second Doppler frequency of the target object based on the second set of sensing signals and the second configuration.

7. The apparatus of claim 6, wherein the at least one processor is further configured to:
transmit, to a network node, a first indication of the first Doppler frequency; and
transmit, to the network node, a second indication of the second Doppler frequency.

8. The apparatus of claim 6, wherein the at least one processor is further configured to:
calculate a velocity of the target object based on the first Doppler frequency and the second Doppler frequency; and
transmit, to a network node, a velocity report based on the calculated velocity of the target object.

9. The apparatus of claim 1, wherein the at least one processor is further configured to:
transmit the first set of sensing signals to the first reflection path based on the first time-domain rotation coefficient.

10. The apparatus of claim 9, wherein, to transmit the first set of sensing signals, the at least one processor is configured to:
calculate a multiplicative factor for each of a set of periodical time occasions of the first set of sensing signals based on the first time-domain rotation coefficient;
rotate the first set of sensing signals based on a base sensing reference signal and a corresponding calculated multiplicative factor for each of the set of periodical time occasions; and
transmit the rotated first set of sensing signals to the first reflection path.

11. (canceled)

12. (canceled)

13. An apparatus for wireless communication at a wireless device, comprising:
memory; and
at least one processor coupled to the memory and, based at least in part on information stored in the memory, the at least one processor is configured to:
obtain a first configuration of a first set of sensing signals associated with a first reflection path, wherein each of the first set of sensing signals is associated with a first time-domain rotation coefficient; and
forward the first set of sensing signals based on the first time-domain rotation coefficient.

14. The apparatus of claim 13, wherein, to obtain the first configuration, the at least one processor is configured to receive the first configuration from a network node, wherein, to forward the first set of sensing signals, the at least one processor is configured to reflect the first set of sensing signals based on the first time-domain rotation coefficient.

15. The apparatus of claim 14, wherein, to reflect the first set of sensing signals, the at least one processor is configured to:
calculate a multiplicative factor for each of a set of periodical time occasions of the first set of sensing signals based on the first time-domain rotation coefficient; and
reflect the first set of sensing signals based on a corresponding calculated multiplicative factor for each of the set of periodical time occasions.

16. The apparatus of claim 14, wherein the wireless device comprises a reconfigurable intelligent surface (RIS).

17. (canceled)

18. The apparatus of claim 14, wherein the at least one processor is further configured to:
receive a second configuration of a second set of sensing signals associated with a second reflection path, wherein each of the second set of sensing signals is associated with a second time-domain rotation coefficient; and
reflect the second set of sensing signals based on the second time-domain rotation coefficient, wherein the first reflection path and the second reflection path comprise a target object.

19. The apparatus of claim 13, wherein, to forward the first set of sensing signals, the at least one processor is configured to transmit the first set of sensing signals based on the first time-domain rotation coefficient.

20. The apparatus of claim 19, wherein, to transmit the first set of sensing signals, the at least one processor is configured to:
calculate a multiplicative factor for each of a set of periodical time occasions based on the first time-domain rotation coefficient;
rotate the first set of sensing signals based on a base sensing reference signal and a corresponding calculated multiplicative factor for each of the set of periodical time occasions; and
transmit the rotated first set of sensing signals to the first reflection path.

21. (canceled)

22. (canceled)

23. The apparatus of claim 13, wherein the at least one processor is further configured to:
obtain a second configuration of a second set of sensing signals associated with a second reflection path, wherein each of the second set of sensing signals is associated with a second time-domain rotation coefficient; and
forward the second set of sensing signals based on the second time-domain rotation coefficient, wherein the first reflection path and the second reflection path comprise a target object.

24. The apparatus of claim 13, wherein the at least one processor is further configured to:
receive the first set of sensing signals via the first reflection path; and
calculate a first Doppler frequency of a target object based on the first set of sensing signals and the first time-domain rotation coefficient.

25. The apparatus of claim 24, wherein, to calculate the first Doppler frequency of the target object, the at least one processor is configured to:
calculate a multiplicative factor for each of a set of periodical time occasions of the first set of sensing signals based on the first time-domain rotation coefficient; and
measure the first set of sensing signals based on a corresponding calculated multiplicative factor for each of the set of periodical time occasions.

26. (canceled)

27. (canceled)

28. The apparatus of claim 24, wherein the at least one processor is further configured to:
obtain a second configuration of a second set of sensing signals associated with a second reflection path, wherein each of the second set of sensing signals is associated with a second time-domain rotation coefficient;
receive the second set of sensing signals via the second reflection path; and
calculate a second Doppler frequency of the target object based on the second set of sensing signals and the second configuration.

29. (canceled)

30. The apparatus of claim 28, wherein the at least one processor is further configured to:
calculate a velocity of the target object based on the first Doppler frequency and the second Doppler frequency; and
transmit, to a network node, a velocity report based on the calculated velocity of the target object.
